(19) United States
(12) Patent Application Publication
(10) Pub. No.: US 2008/0182640 A1
(43) Pub. Date: Jul. 31, 2008

(54) MULTIPLE PARTICIPANTS TYPE GAMING DEVICE AND PLAYING METHOD THEREOF

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/017,651

(22) Filed: Jan. 22, 2008

(30) Foreign Application Priority Data
Jan. 23, 2007 (JP) JP2007-012575

(51) Int. Cl. A63F 13/00

(52) U.S. Cl. 463/17

(57) ABSTRACT

A gaming device determines whether medals are to be paid at each station or not according to two dice symbols for judgment displayed by a dice rotation device and one dice symbol for judgment rearranged individually at each station.

### CROSS REFERENCE TO RELATED APPLICATIONS

This application is based upon and claims the benefit of priority from the prior Japanese Patent Application No. 2007-012575, filed on Jan. 23, 2007, the entire contents of which are incorporated herein by reference.

### BACKGROUND OF THE INVENTION

1. Field of the Invention

The present invention relates to a gaming device for playing games by using gaming media such as coins, bills, etc., and a playing method thereof.

2. Description of the Related Art

U.S. Pat. No. 6,981,635 B1 discloses a slot machine for playing games in a stand-alone fashion.

U.S. Pat. No. 7,040,984 B2 discloses a technique by which a plurality of slot machines are connected to a central control device respectively, but even in this technique, the games are effectively played in a stand-alone fashion.

On the other hand, the multiple participants type games such as card games using trumps and roulette games are very popular. One of the reasons for their popularity is considered to be that a player is less likely to get bored by the game in the multiple participant type game than a stand-alone type game such as the slot machine described above.

### SUMMARY OF THE INVENTION

The present invention has been achieved in order to solve the problems described above, and has an object to provide a gaming device and a playing method of a game for providing new multiple participant type games.

The first aspect of the present invention is a gaming device, comprising: a common display configured to display symbols; a plurality of stations having an individual display configured to arrange and rearrange symbols; and a controller configured to determine whether a prize is to be awarded at one of the stations or not, for each station, according to symbols displayed on the common display and symbols rearranged on the individual display provided at the one of the stations.

According to the first aspect of the present invention, there is provided a new multiple participant type game in which whether a prize is to be awarded at each station or not is determined according to symbols displayed on a common display and symbols rearranged individually at each station.

In addition, a player cannot judge whether a prize is to be awarded to himself or not unless attentions are paid to both the common display and the station at which himself is playing the game, so that it is expected to be less likely to get bored by the game compared with the case where it suffices to pay attentions only to the common display or the case where it suffices to pay attentions only to the station at which himself is playing the game.

Each station may be capable of accepting a betting operation on a combination of symbols displayed on the common display and symbols rearranged on the individual display of each station, and the controller may be configured to award the prize at an already bet station at which the betting operation is accepted, when the already bet station exists and the combination of symbols displayed on the common display and symbols displayed on the individual display provided at the already bet station coincides with a combination on which the betting operation is made.

According to the above described configuration, there is provided a new multiple participant type game in which a prize is awarded at a station at which a betting operation is made in the case where a combination of symbols displayed by the common display and symbols rearranged individually at each station coincides with a combination for which the betting operation is made. Namely, a player can enjoy a game for guessing what a combination of symbols displayed by the common display and symbols rearranged individually at the station at which the betting operation is made by himself is going to be.

Symbols displayed on the common display and symbols arranged and rearranged on the individual display all may indicate numerical values, and the controller may be configured to calculate a total of numerical values indicated by symbols displayed on the common display and numerical values indicated by symbols rearranged on the individual display, for each station, and award the prize at a station for which a difference between the calculated total and a prescribed value is smallest.

According to the above described configuration, there is provided a new multiple participant type game in which a prize is awarded at a station at which a difference between a total value of a numerical value indicated by symbols displayed on the common display and a numerical value indicated by symbols rearranged individually at each station and a prescribed value is smallest.

The second aspect of the present invention is a gaming device, comprising: a common display configured to display symbols; a roulette gaming device configured to rotate a roulette wheel having a plurality of pockets to which numbers are set in correspondence in advance, launch a ball that can be received by the pockets onto the roulette wheel, and then stop the roulette wheel; a plurality of stations capable of accepting a betting operation on any of the pockets; and a controller configured to determine whether a prize is to be awarded at each station or not, according to symbols displayed on the common display, a pocket which received the ball, and a result of the betting operation.

According to the second aspect of the present invention, there is provided a new multiple participant type game in which whether a prize is to be awarded at each station or not is determined according to symbols displayed on a common display, a pocket which received a ball, and a result of a betting operation.

The third aspect of the present invention is a playing method of a game, comprising: displaying symbols on a common display; rearranging symbols arranged on an individual display provided at each of a plurality of stations; and determining whether a prize is to be awarded at one of the stations or not, for each station, according to symbols displayed on the common display and symbols rearranged on the individual display provided at the one of the stations.

According to the third aspect of the present invention, there is provided a new multiple participant type game in which whether a prize is to be awarded at each station or not is determined according to symbols displayed on a common display and symbols rearranged individually at each station.

In addition, a player cannot judge whether a prize is to be awarded to himself or not unless attentions are paid to both the common display and the station at which himself is playing the game, so that it is expected to be less likely to get bored by the game compared with the case where it suffices to pay attentions only to the common display or the case where it suffices to pay attentions only to the station at which himself is playing the game.

The playing method may further comprise: accepting at each station a betting operation on a combination of symbols displayed on the common display and symbols rearranged on the individual display of each station, and awarding the prize at an already bet station at which the betting operation is accepted, when the already bet station exists and the combination of symbols displayed on the common display and symbols displayed on the individual display provided at the already bet station coincides with a combination on which the betting operation is made.

According to the above described configuration, there is provided a new multiple participant type game in which a prize is awarded at a station at which an betting operation is made in the case where a combination of symbols displayed by the common display and symbols rearranged individually at each station coincides with a combination for which the betting operation is made. Namely, a player can enjoy a game for guessing what a combination of symbols displayed by the common display and symbols rearranged individually at the station at which the betting operation is made by himself is going to be.

The playing method may further comprise: displaying symbols indicating numerical values on the common display; arranging and rearranging symbols indicating numerical values on the individual display; calculating a total of numerical values indicated by symbols displayed on the common display and numerical values indicated by symbols rearranged on the individual display, for each station; and awarding the prize at a station for which a difference between the calculated total and a prescribed value is smallest.

According to the above described configuration, there is provided a new multiple participant type game in which a prize is awarded at a station at which a difference between a total value of a numerical value indicated by symbols displayed on the common display and a numerical value indicated by symbols rearranged individually at each station and a prescribed value is smallest.

The fourth aspect of the present invention is a playing method of a game, comprising: displaying symbols on a common display; rotating a roulette wheel having a plurality of pockets to which numbers are set in correspondence in advance, launching a ball that can be received by the pockets onto the roulette wheel, and then stopping the roulette wheel; accepting a betting operation on any of the pockets at each of a plurality of stations; and determining whether a prize is to be awarded at each station or not, according to symbols displayed on the common display, a pocket which received the ball, and a result of the betting operation.

According to the fourth aspect of the present invention, there is provided a new multiple participant type game in which whether a prize is to be awarded at each station or not is determined according to symbols displayed on a common display, a pocket which received a ball, and a result of a betting operation.

### BRIEF DESCRIPTION OF THE DRAWINGS

FIG. 1 is a perspective view showing a gaming device according to the first embodiment of the present invention.

FIG. 2 is a cross sectional view showing a dice rotation device according to the first embodiment.

FIG. 3 is an explanatory diagram showing an image displayed on a liquid crystal display device according to the first embodiment.

FIG. 4 is an explanatory diagram showing an image displayed on a liquid crystal display device according to the first embodiment.

FIG. 5 is an explanatory diagram showing an image displayed on a liquid crystal display device according to the first embodiment.

FIG. 6 is an explanatory diagram showing an image displayed on a liquid crystal display device according to the first embodiment.

FIG. 7 is an explanatory diagram showing an image displayed on a liquid crystal display device according to the first embodiment.

FIG. 8 is an explanatory diagram showing an image displayed on a liquid crystal display device according to the first embodiment.

FIG. 9 is a block diagram showing an electric configuration of a gaming device according to the first embodiment.

FIG. 10 is a block diagram showing an electric configuration of a station according to the first embodiment.

FIG. 11 is a flow chart showing a processing procedure by a gaming device according to the first embodiment.

FIG. 12 is a flow chart showing a processing procedure by a gaming device according to the first embodiment.

FIG. 13 is a flow chart showing a processing procedure by a gaming device according to the first embodiment.

FIG. 14 is a flow chart showing a processing procedure by a gaming device according to the first embodiment.

FIG. 15 is a flow chart showing a processing procedure by a gaming device according to the second embodiment.

FIG. 16 is a perspective view showing a gaming device according to the third embodiment of the present invention.

FIG. 17 is a plan view showing a liquid crystal display device according to the third embodiment.

FIG. 18 is an explanatory diagram showing an image displayed on a liquid crystal display device according to the third embodiment.

FIG. 19 is an explanatory diagram showing an image displayed on a liquid crystal display device according to the third embodiment.

FIG. 20 is an explanatory diagram showing an image displayed on a liquid crystal display device according to the third embodiment.

FIG. 21 is an explanatory diagram showing an image displayed on a liquid crystal display device according to the third embodiment.

FIG. 22 is an explanatory diagram showing an image displayed on a liquid crystal display device according to the third embodiment.

FIG. 23 is a block diagram showing an electric configuration of a gaming device according to the third embodiment.

FIG. 24 is a block diagram showing an electric configuration of a station according to the third embodiment.

FIG. 25 is a flow chart showing a processing procedure by a gaming device according to the third embodiment.

FIG. 26 is a flow chart showing a processing procedure by a gaming device according to the third embodiment.

FIG. 27 is a flow chart showing a processing procedure by a gaming device according to the third embodiment.

### DETAILED DESCRIPTION OF THE EMBODIMENTS

### First Embodiment

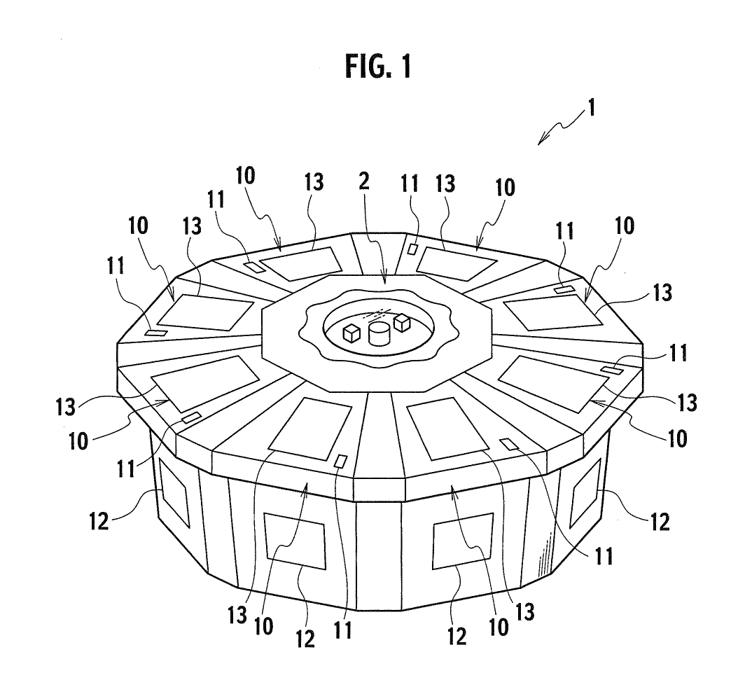

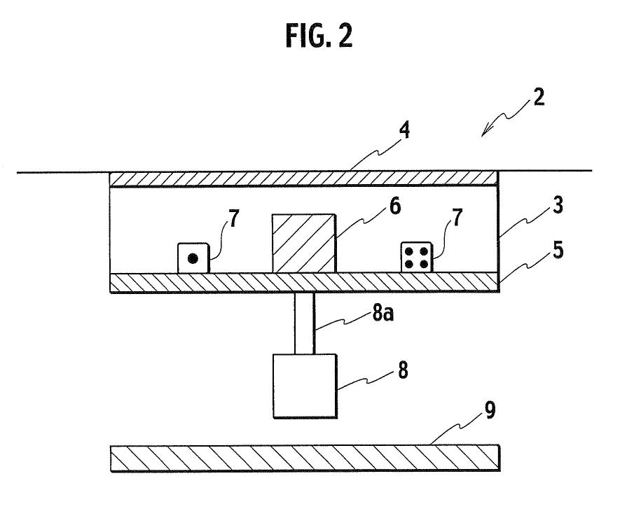

FIG. 1 is an explanatory diagram showing an outward appearance of a gaming device 1 according to the first embodiment, and FIG. 2 is a side cross sectional view of a dice rotation device 2 (common display).

As shown in FIG. 1, the gaming device 1 has a dice rotation device 2 and eight stations 10. The dice rotation device 2 is arranged at a center of the gaming device 1, and the stations 10 are arranged to surround the dice rotation device 2. The station 10 has a medal insertion slot 11, a medal payout opening 12, and a liquid crystal display device 13 (individual display). A player plays a game by using the station 10.

As shown in FIG. 2, the dice rotation device 2 has a hollow portion 3, a transparent plate 4, a rotation plate 5, a protruded portion 6, two dices 7, a motor 8, a rotational shaft 8a, and a scanner 9.

The hollow portion 3 is a column shaped space, which is formed at a central part of an upper face of the gaming device 1. The transparent plate 4 is in a disk shape, and covering an upper face of the hollow portion 3. The rotation plate 5 is in a disk shape, and covering a lower face of the hollow portion 3. The rotation plate 5 is formed by a transparent member. The protruded portion 6 is formed by a transparent member, and provided at a center of an upper face of the rotation plate 5. Note that the protruded portion 6 has its shape determined such that dices 7 and the motor 8 will not overlap when the rotation plate 5 is viewed from the scanner 9. The two dices 7 are provided at a surrounding part of the protruded portion 6 on an upper face of the rotation plate 5. The dice 7 is a cubic dice commonly used, where a dice symbol (symbol) indicating a numerical value of any one from 1 to 6 is drawn on each face of the dice 7.

The motor 8 is provided on a lower side of the rotation plate 5. The rotational shaft 8a connects a center of a lower face of the rotation plate 5 and the motor 8. The motor 8 rotates the rotational shaft 8a. The rotation plate 5 will be rotated integrally with the rotational shaft 8a (that is, with the rotational shaft 8a as a rotation axis). In this way, two dices 7 will be rolled on the rotation plate 5. The scanner 9 is provided on a lower side of the motor B. The scanner 9 acquires an image in which lower faces of the dices 7 (that is, faces in contact with an upper face of the rotation plate 5) are drawn, by scanning an upper face of the rotation plate 5 almost entirely. Consequently, it becomes possible to judge the dice symbols drawn on upper faces of the dices 7 (that is, faces facing to the transparent plate 4), according to this image. This is because a total of numerical values indicated by dice symbols on opposite sides always becomes “6”. Note that the upper faces of the dices 7 are faces visible by the players.

The gaming device 1 determines whether medals (a prize) are to be paid at each station 10 or not, according to the dice symbols respectively displayed by the two dices 7 (that is, the dice symbols drawn on the upper faces of the dices 7) and a dice symbol 45 (symbol) to be described below.

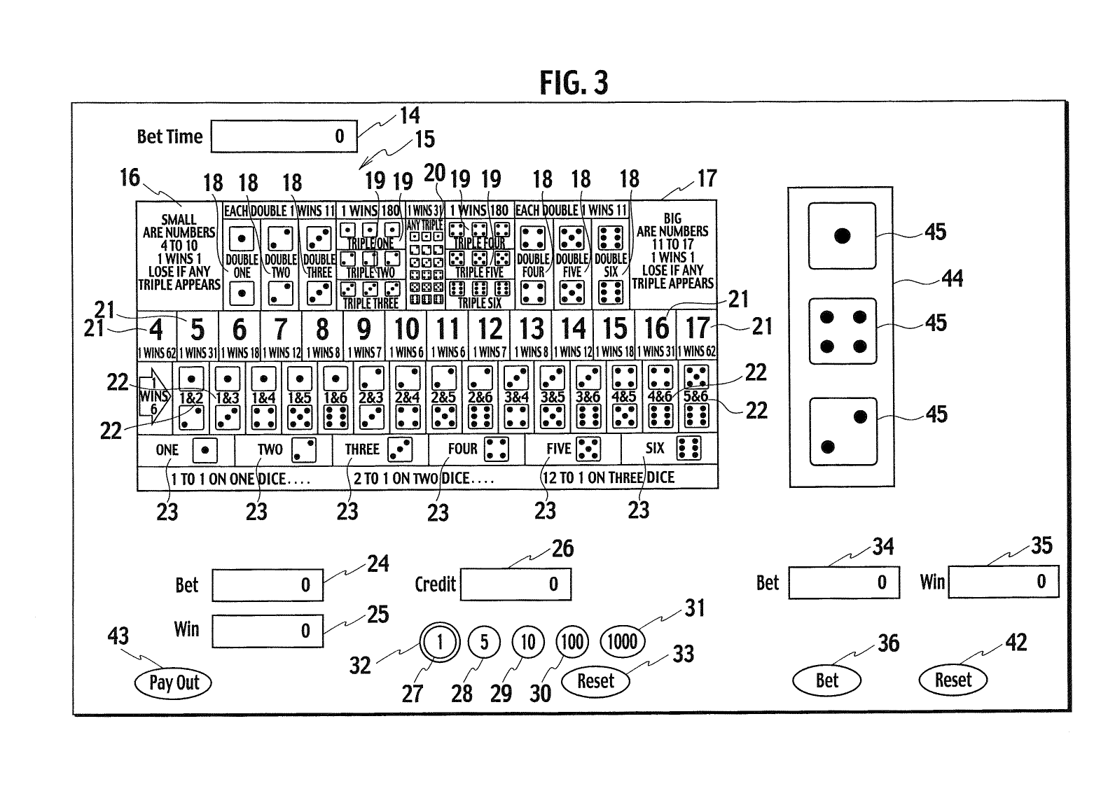

FIG. 3 to FIG. 8 show images displayed on the liquid crystal display device 13. On a surface of the liquid crystal display device 13, a touch panel 52 is provided, and the player can bet medals or receive a payout of medals by pressing the touch panel 52 while watching images displayed on the liquid crystal display device 13. In the following description, “pressing buttons” or “pressing panels” implies pressing portions at which these buttons or panels are displayed within the touch panel 52.

The liquid crystal display device 13 displays a betting time display frame 14, a betting operation panel 15, a betting number display frame 24, an acquired medal number display frame 25, a credit number display frame 26, betting unit determination buttons 27 to 31, a cursor 32, reset buttons 33 and 42, a betting button 36, a payout button 43, and a reel 44.

The reel 44 is the so called video reel, where a plurality of dice symbols 45 are drawn on its circumferential face. Each dice symbol 45 indicates a numerical value of any one from 1 to 6. When the reel 44 is stopped, three dice symbols 45 will be arranged along a vertical direction of FIG. 3. When the reel 44 is rotated, the dice symbols 45 will be scrolled, and three dice symbols 45 will be rearranged as the reel 44 is stopped again. The gaming device 1 determines whether medals are to be paid at each station 10 or not according to a central dice symbol 45 among the three rearranged dice symbols 45, and the dice symbols respectively displayed by the two dices 7. In the following, the central dice symbol 45 among the three rearranged dice symbols 45 and the dice symbols respectively displayed by the two dices 7 will also be referred simply as “three dice symbols for judgment”.

Inside the betting time display frame 14, a remaining time during which the player can bet medals, that is the betting time, is displayed. An initial value of this betting time is 60, and it is decreased by one whenever one second elapses.

The betting operation panel 15 comprises a small bet panel 16, a big bet panel 17, double bet panels 18, triple bet panels 19, an any triple bet panel 20, total bet panels 21, pair bet panels 22, and number bet panels 23.

The betting operation panel 15 will be used when the player bets medals with respect to a Sic Bo game. The Sic Bo game is a game in which the player guesses which combination is going to be a combination of the three dice symbols for judgment. Namely, the player guesses a combination of the three dice symbols for judgment, and bets medals with respect to the guessed combination. The player gets a payout of medals when the combination on which medals are bet coincides with a combination of the three dice symbols for judgment. The operation for betting medals, that is a concrete method for the betting operation will be described below. Note that one Sic Bo game is started as the processing of the step S2 to be described below is started, and finished when all the stations 10 finish the station side processing. A payout rate (a number of medals to be paid with respect to one medal) is set for each combination.

The small bet panel 16 deals with combinations for which “a total of numerical values respectively indicated by the three dice symbols for judgment is greater than or equal to 4 and less than or equal to 10, and at least one of the numerical values indicates by the three dice symbols for judgment is different from others” among the combinations of the three dice symbols for judgment (referred also as “small combinations” in the following). The small bet panel 16 will be used at a time of betting medals on the small combinations. The payout rate set for the small combinations is 1.

The big bet panel 17 deals with combinations for which “a total of numerical values respectively indicated by the three dice symbols for judgment is greater than or equal to 11 and less than or equal to 17, and at least one of the numerical values indicates by the three dice symbols for judgment is different from others” among the combinations of the three dice symbols for judgment (referred also as “big combinations” in the following). The big bet panel 17 will be used at a time of betting medals on the big combinations. The payout rate set for the big combinations is 1.

The double bet panel 18 indicates a combination ‘n, n’ (n=integer in a range of 1 to 6) of the two identical numerical values. The double bet panel 18 deals with combinations for which “a combination of numerical values indicated by arbitrary two dice symbols becomes ‘n, n,’” among the combinations of the three dice symbols for judgment (referred also as “‘n, n’ combination” in the following”). The double bet panel 18 will be used at a time of betting medals on the ‘n, n’ combinations. The payout rate set for the ‘n, n’ combinations is 11.

The triple bet panel 19 indicates a combination ‘n, n, n’ (n=integer in a range of 1 to 6) of the three identical numerical values. The triple bet panel 19 deals with combinations for which “a combination of numerical values indicated by the three dice symbols for judgment becomes ‘n, n, n’” among the combinations of the three dice symbols for judgment (referred also as “‘n, n, n’ combination” in the following”). The triple bet panel 19 will be used at a time of betting medals on the ‘n, n, n’ combinations. The payout rate set for the ‘n, n, n’ combinations is 180.

The any triple bet panel 20 deals with combinations for which “numerical values indicated by the three dice symbols for judgment become all identical” among the combinations of the three dice symbols for judgment (referred also as “any triple combinations” in the following). The any triple bet panel 20 will be used at a time of betting medals on the any triple combinations. The payout rate set for the any triple combinations is 31.

The total bet panel 21 indicates a numerical value n (n=any one integer among 4 to 17). The total bet panel 21 deals with combinations for which “a total of numerical values indicated by the three dice symbols for judgment becomes n” among the combinations of the three dice symbols for judgment (referred also as “total ‘n’ combinations” in the following). The total bet panel 21 will be used at a time of betting medals on the total ‘n’ combinations. The payout rate set for the total ‘n’ combinations is any one of 62, 31, 18, 12, 8, 7 and 6.

The pair bet panel 22 indicates a combination ‘n, m’ of two different numerical values (n<m, n=integer in a range of 1 to 5, m=integer in a range of 2 to 6). The pair bet panel 22 deals with combinations for which “a combination of numerical values indicated by arbitrary two dice symbols becomes ‘n, m’″ among the combinations of the three dice symbols for judgment (referred also as “‘n, m’ combinations in the following). The pair bet panel 22 will be used at a time of betting medals on the ‘n, m’ combinations. The payout rate set for the ‘n, m’ combinations is 6.

The number bet panel 23 indicates a numerical value n (n=any one integer among 1 to 6). The number bet panel 23 deals with combinations for which “one or more dice symbols indicating n exist” among the combinations of the three dice symbols for judgment (referred also as “combinations with one or more dice symbols indicating ‘n’” in the following). The number bet panel 23 will be used at a time of betting medals on the combinations with one or more dice symbols indicating ‘n’. The payout rate set for the combinations with one or more dice symbols indicating ‘n’ is any one of 1, 2 and 3. Namely, the payout rate becomes 1 when only one dice symbol indicating ‘n’ exists, the payout rate becomes 2 when two dice symbols indicating ‘n’ exist, and the payout rate becomes 3 when three dice symbols indicating ‘n’ exist.

Inside the betting number display frame 24, a total number of medals bet with respect to the Sic Bo game will be displayed. Inside the acquired medal number display frame 25, a total number of medals newly acquired by the player in the current Sic Bo game will be displayed. Inside the credit number display frame 26, a total number of medals to be paid to the player at the station 10 displaying the credit number display frame 26 (referred also as “a total credit number” in the following) will be displayed.

The betting unit determination buttons 27 to 31 will be used at a time of setting the number of medals to be bet with respect to the Sic Bo game or the slot game by a single betting operation (referred also as “a unit betting number of medals” in the following). The numerical values drawn on the betting unit determination buttons 27 to 31 indicate a unit betting number of medals that can be set by pressing that button. For example, the player sets the unit betting number of medals to “1” by pressing the betting unit determination button 27. Note that, the unit betting number of medals is set to “1” in the initial state. The slot game is a game in which, when a combination of the three dice symbols for judgment becomes a certain combination (such a combination will be referred also as “a medal payout target combination” in the following), medals will be paid according to that medal payout target combination. The payout rate is set for each medal payout target combination. As the medal payout target combination, it is possible to consider a combination in which the three dice symbols for judgment become identical, a combination in which two dice symbols among the three dice symbols for judgment become identical, a combination in which numerical values indicated by the three dice symbols for judgment are consecutive, etc., for example. One slot game is started as the processing of the step S2 to be described below is started, and finished when all the stations 10 finish the station side processing. Namely, the Sic Bo game and the slot game will be executed in parallel.

The cursor 32 will be displayed at a button corresponding to the unit betting number of medals currently set. The reset button 33 will be used when the player cancels the betting operation with respect to the Sic Bo game. Inside the betting number display frame 34, a total number of medals bet with respect to the slot game will be displayed. Inside the acquired medal number display frame 35, a total number of medals newly acquired by the player in the current slot game will be displayed. The reset button 42 will be used when the player cancels the betting operation with respect to the slot game. The bet button 36 will be used when the player makes the betting operation with respect to the slot game. It will be described more specifically below. The payout button 43 will be used when the player receives the payout of as much medals as the total credit number.

FIG. 3 shows a screen displayed by each liquid crystal display device 13 when the medals are not entered at all the stations 10 (namely, when “0” is displayed inside all the credit number display frames 26).

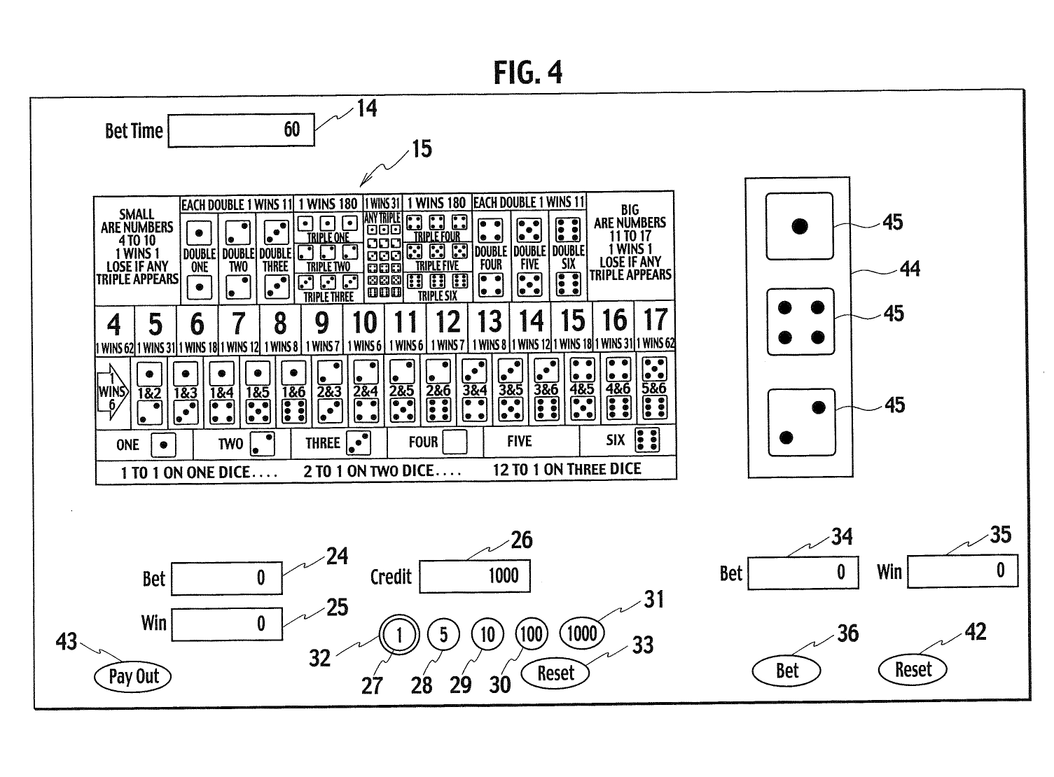

When the medals are not entered at all the stations 10, if the player enters 1000 medals from a medal insertion slot 11 of any station 10, a screen shown in FIG. 4 will be displayed at the liquid crystal display device 13 of that station 10. Namely, “1000” will be displayed inside the credit number display frame 26, and “60” will be displayed inside the betting time display frame 14. After that, the numerical value inside the betting time display frame 14, that is the betting time, is decreased by one whenever one second elapses, so that the player makes the betting operation before the betting time becomes “0”.

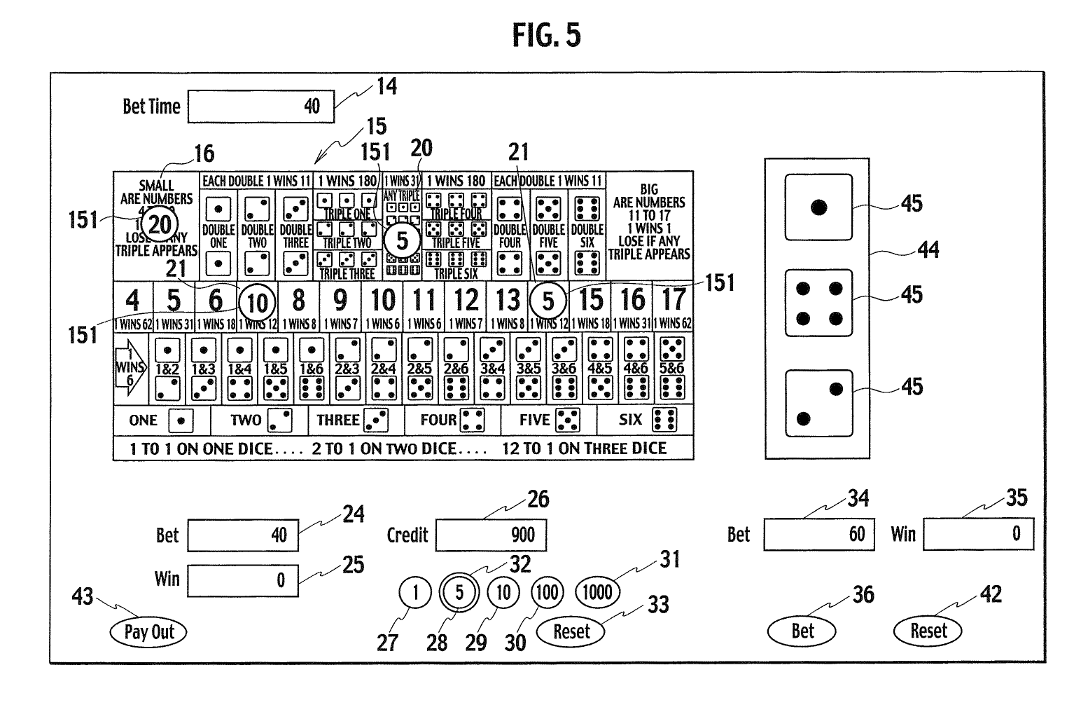

Here, the method of the betting operation will be described according to FIG. 5. The player makes the betting operation with respect to the Sic Bo game by pressing any one panel within the betting operation panel 15. More specifically, the player presses a panel corresponding to a combination of his own guess within the betting operation panel 15. As a result, the medals will be bet with respect to that panel (namely, the betting operation is made with respect to a combination of his own guess). On the panel on which the medals are bet, a chip 151 will be displayed. A numerical value is displayed at a center of the chip 151, and this numerical value indicates a total number of medals bet on the panel on which the chip 151 is displayed. The numerical value displayed on the chip 151 is increased as much as the unit betting number of medals currently set, every time the player presses the panel once. The total number of medals bet with respect to the Sic Bo game will be displayed inside the betting number display frame 24. When the reset button 33 is pressed, the total credit number is increased as much as the numerical value displayed inside the betting number display frame 24 until then, the chips 151 are all deleted, and “0” will be displayed inside the betting number display frame 24 (namely, the number of medals bet with respect to the Sic Bo game becomes “0”).

In FIG. 5, 20 medals are bet on the small combinations, 5 medals are bet on the any triple combinations, 10 medals are bet on the total ‘7’ combinations, and 14 medals are bet on the total ‘14’ combinations. In this case, the total number of medals bet with respect to the Sic Bo game is “40”, so that this numerical value will be displayed inside the betting number display frame 24.

On the other hand, the player makes the betting operation with respect to the slot game by pressing the bet button 36. Namely, the player can bet medals with respect to the slot game by pressing the bet button 36. The number of medals that are bet with respect to the slot game will be increased as much as the unit betting number of medals currently set, every time the player presses the bet button 36 once. The total number of medals bet with respect to the slot game will be displayed inside the betting number display frame 34. In FIG. 5, 60 medals are bet with respect to the slot game.

The total credit number is decreased as much as a total of the number of medals bet on the Sic Bo game and the number of medals bet on the slot game. In FIG. 5, the total credit number (that is, the numerical value displayed inside the credit number display frame 26) is “1000” initially, but 40 medals are bet on the Sic Bo game and 60 medals are bet on the slot game, so that the total credit number is decreased by “100” and becomes “900”. Note that, when the reset button 42 is pressed, the total credit number will be increased as much as the numerical value displayed inside the betting number display frame 34 until then, and “0” will be displayed inside the betting number display frame 34 (namely, the number of medals bet with respect to the slot game becomes “0”).

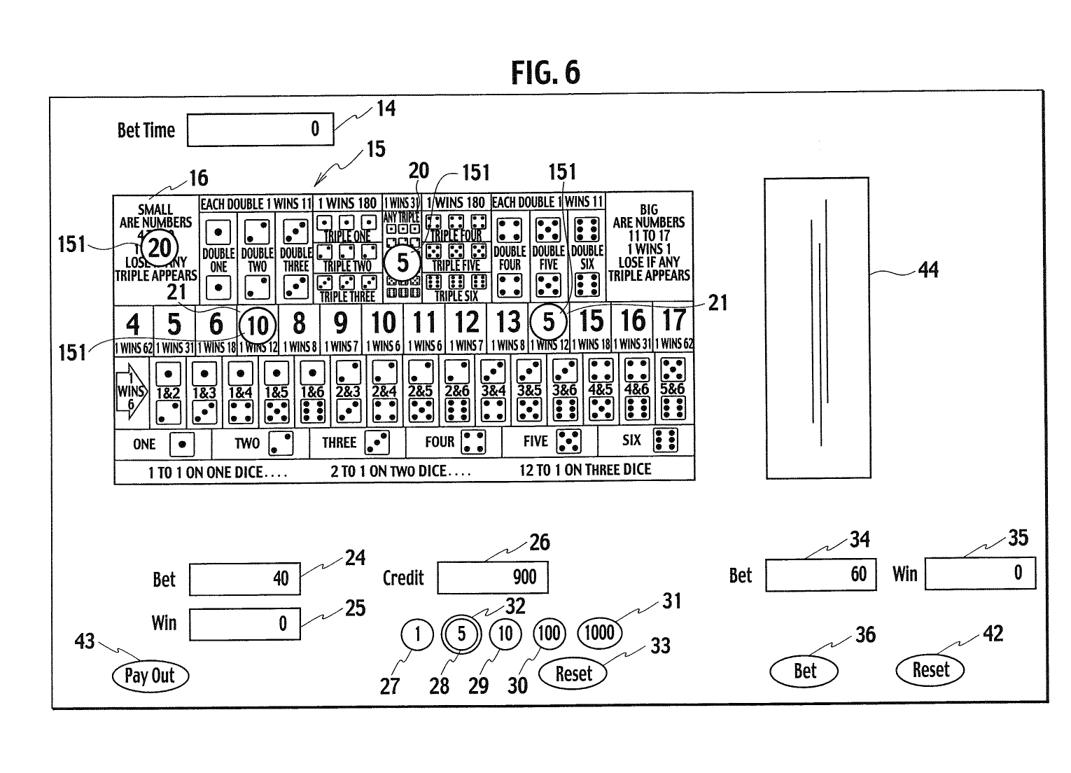

After that, when the betting time becomes “0”, the acceptance of the betting operation is finished, and the rotation of the reel 44 is started. A manner by which the reel 44 rotates is shown in FIG. 6. On the other hand, the dice rotation device 2 starts the rotation of the dices 7.

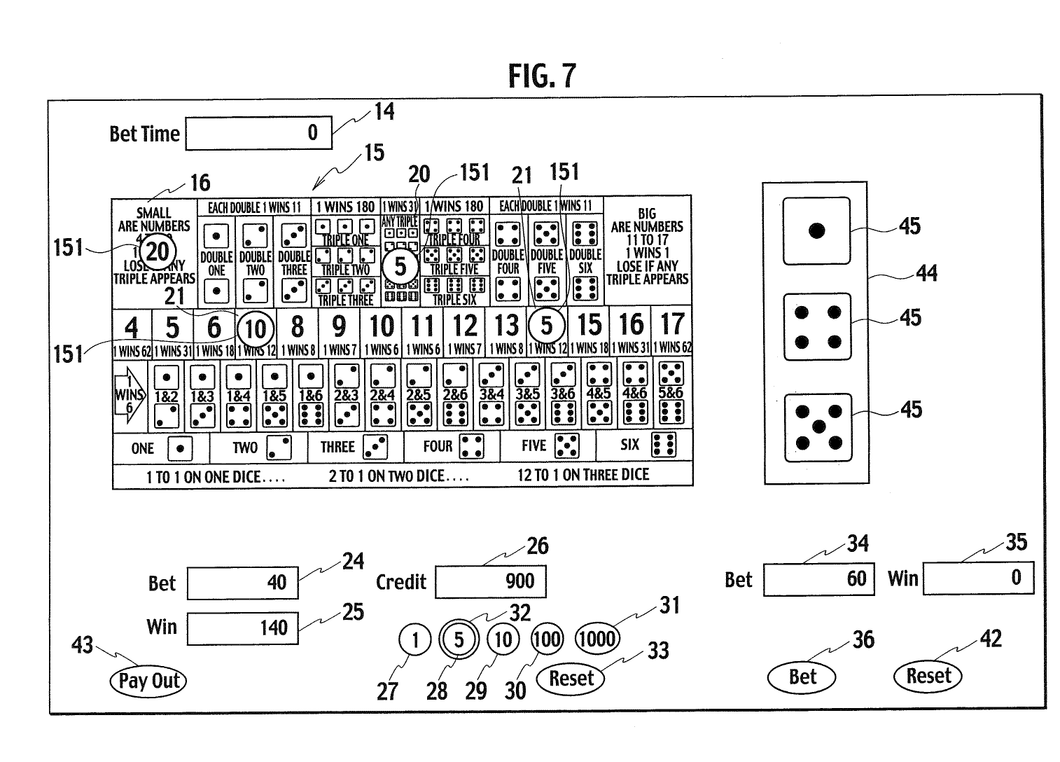

When a certain period of time elapses from the state shown in FIG. 6, the reel 44 is stopped, and the dice rotation device 2 stops the rotation of the dices 7. As a result, the three dice symbols for judgment are ascertained. A manner by which the reel 44 stops is shown in FIG. 7. In this figure, the dices 7 are not shown, but a combination of the three dice symbols for judgment is “1”, “2” and “4”.

After that, if the combination on which the medals are bet by the player and the combination of the three dice symbols for judgment are coinciding, the player newly acquires medals as much as (the number of medals bet on that combination by the player)×(the payout rate set for that combination) in the Sic Bo game. The number of medals newly acquired by the player in the Sic Bo game will be displayed inside the acquired medal number display frame 25.

In addition, if the combination of the three dice symbols for judgment coincides with the medal payout target combination, the player newly acquires medals as much as (the payout rate set for the medal payout target combination))×(the number of medals bet with respect to the slot game by the player) in the slot game. The number of medals newly acquired by the player in the slot game will be displayed inside the acquired medal display frame 35.

In an example shown in FIG. 7, the small combinations and the total ‘7’ combinations among the combinations on which medals are bet by the player are coinciding with the combination of the three dice symbols for judgment, so that the player newly acquires 20×1+10×12=140 medals in the Sic Bo game. This value will be displayed inside the acquired medal number display frame 25.

Note that the combination of “1”, “2” and “4” is not the medal payout target combination in the slot game, so that the player cannot receive the payout of new medals in the slot game. Consequently, “0” will be displayed inside the acquired medal number display frame 35.

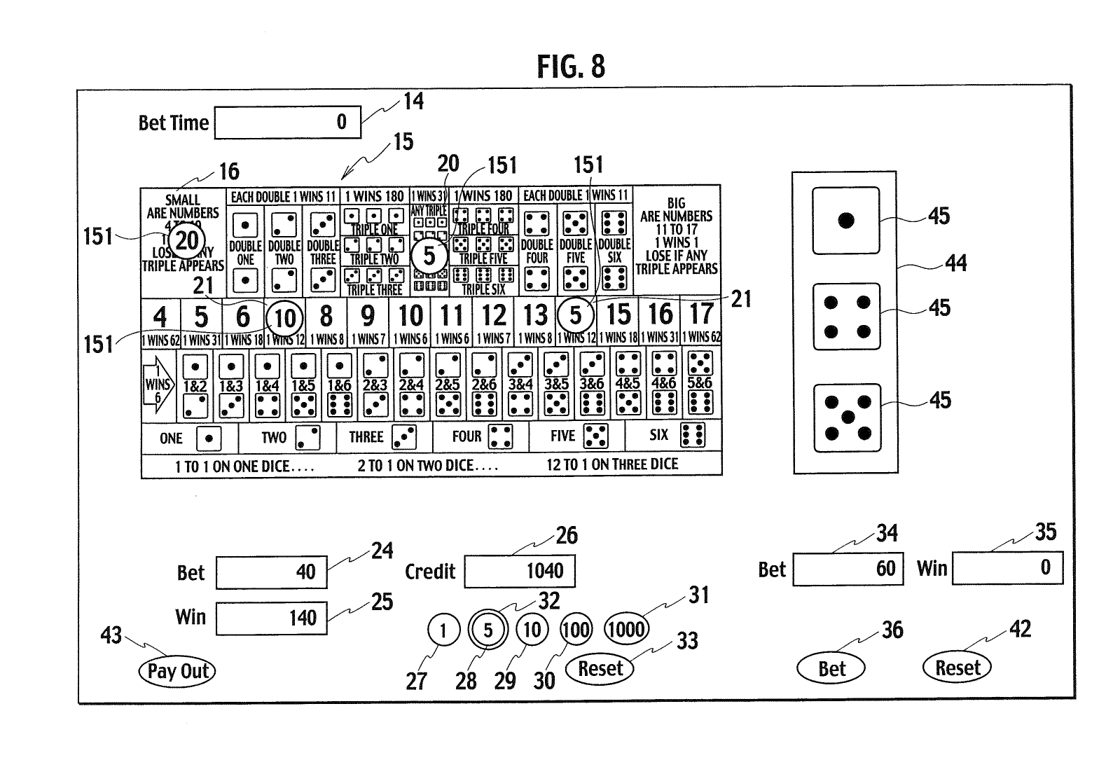

After that, the total credit number is increased as much as the total number of medals newly acquired in the Sic Bo game and the slot game by the player. In the case sown in FIG. 7, the total credit number is increased by “140” from “900” and becomes “1040”, as shown in FIG. 8.

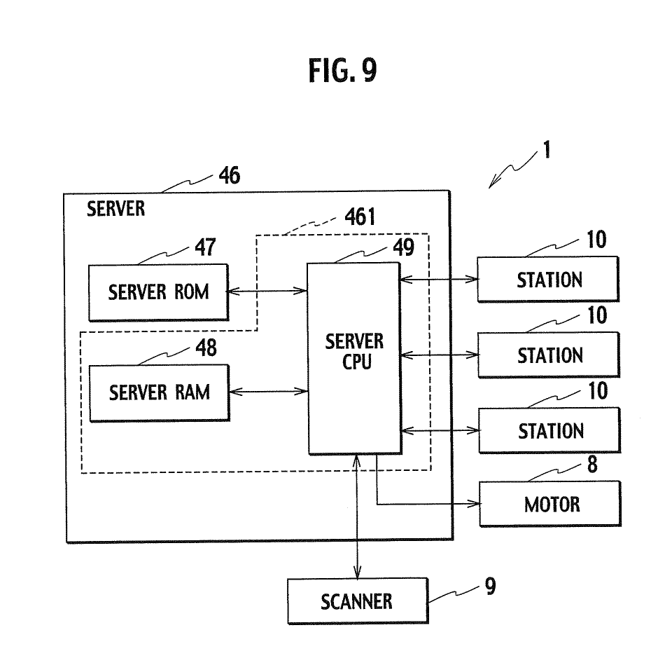

FIG. 9 is a block diagram showing an electric configuration of the gaming device 1. The gaming device 1 has a server 46 and a plurality of stations 10.

The server 46 has a server ROM 47, a server RAM 48, and a server CPU 49 as its electric configuration. A controller 461 is formed by the server RAM 48 and the server CPU 49.

The server ROM 47 stores programs necessary for the operations of the server 46, a correspondence table indicating a correspondence relationship between the combination of the three dice symbols for judgment (the small combinations, the big combinations, the medal payout target combinations, etc., for example) and the payout rates, etc. The server RAM 48 will be used as a work area of the server CPU 49.

The server CPU 49 carries out various types of control according to the programs stored in the server ROM 47. For example, the server CPU 49 carries out a control for determining whether medals are to be paid at each station 10 or not, according to the combinations of the three dice symbols for judgment. In addition, the server CPU 49 also carries out a control of the motor 8 and the scanner 9, and transmission and reception of signals among the stations 10.

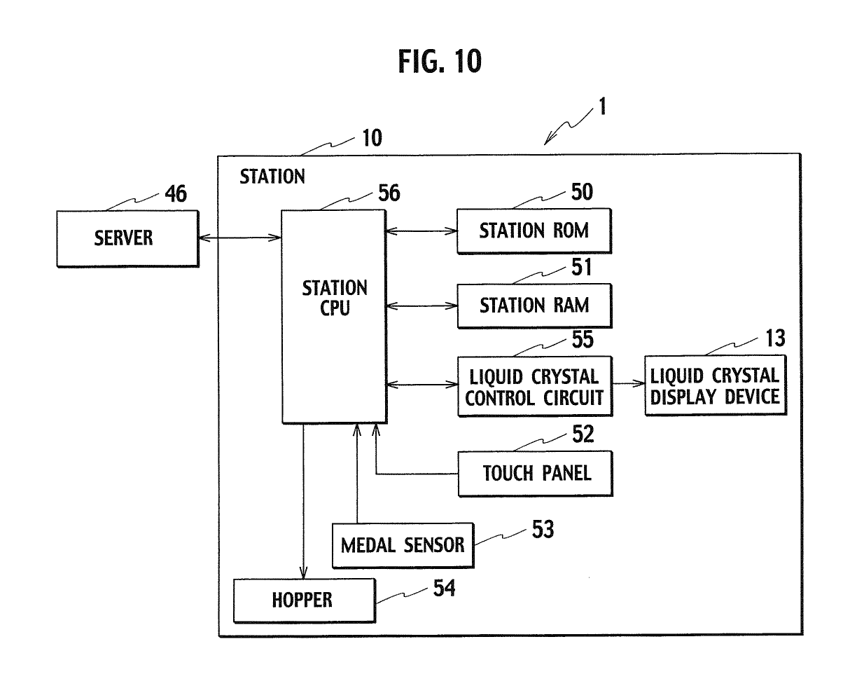

FIG. 10 is a block diagram showing an electric configuration of the station 10. The station 10 has a station ROM 50, a station RAM 51, a touch panel 52, a medal sensor 53, a hopper 54, a liquid crystal control circuit 55, and a liquid crystal display device 13, as its electric configuration.

The station ROM 50 stores programs necessary for the operations of the station 10. The station RAM 51 will be used as a work area of the station CPU 56. The touch panel 52 outputs an operation signal according to a position pressed by the player to the station CPU 56 when it is pressed by the player. The medal sensor 53 detects medals entered from the medal insertion slot 11. The medal sensor 53 outputs a credit detection signal to the station CPU 56 when medals entered from the medal insertion slot 11 are detected. The hopper 54 pays out as many medals as the total credit number from the medal payout opening 12, under the control by the station CPU 56, when the payout button 43 is pressed. The liquid crystal control circuit 55 stores various images (an image shown in FIG. 3, for example), and displays various images on the liquid crystal display device 13, under the control of the station CPU 56.

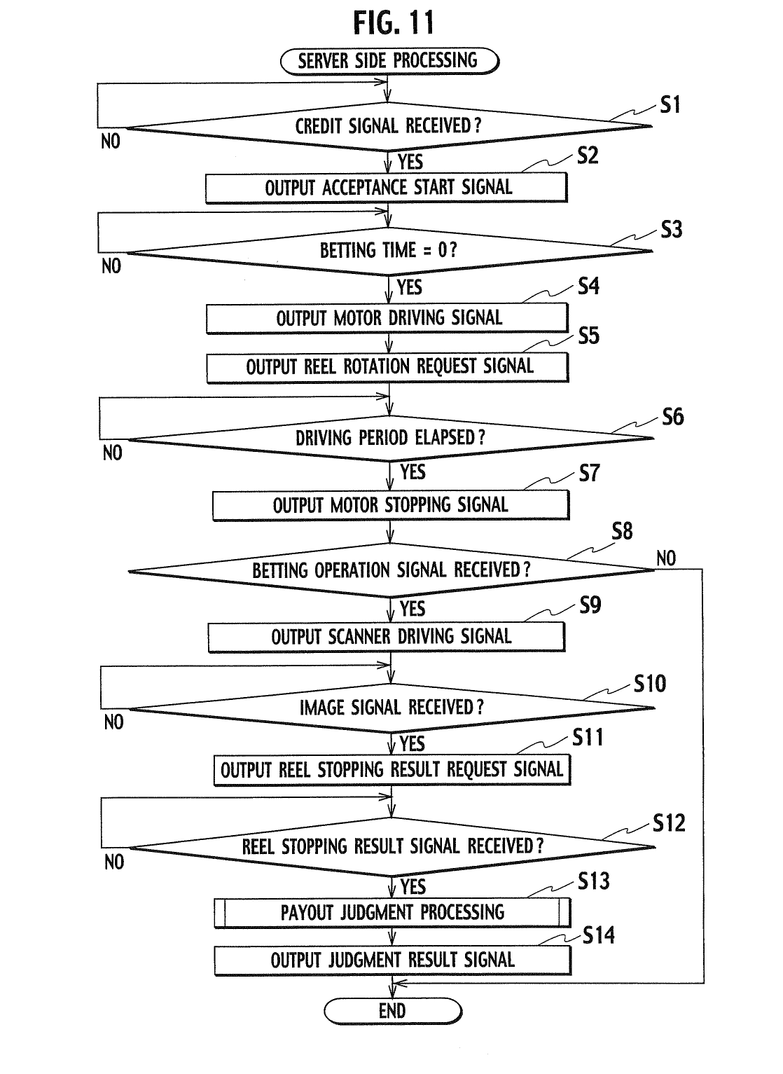

FIG. 11 to FIG. 14 are flow charts showing a procedure of the processing to be carried out by the gaming device 1. The server 46 carries out the server side processing and the payout judgment processing, and the station 10 carries out the station side processing and the credit increasing processing. First, the server side processing will be described.

At the step S1, the server CPU 49 waits until the credit signal is given from any one of the stations 10, and proceeds to the step S2 when the credit signal is given. Note that each station 10 outputs the credit signal to the server CPU 49 when the total credit number stored by that station 10 becomes greater than or equal to 1.

At the step S2, the server CPU 49 outputs an acceptance start signal to each station 10. Each station 10 displays “60”, which is an initial value of the betting time, inside the betting time display frame 14, at a timing of receiving the acceptance start signal, and thereafter, decreases the betting time by one whenever one second elapses. The player can make the betting operation at each station 10 until the betting time becomes “0”.

At the step S3, the server CPU 49 forms a betting time timer in the server RAM 48, and sets its initial value to be “60”. The betting time timer indicates the betting time. The server CPU 49 thereafter decreases a value of the betting time timer by one whenever one second elapses, and waits until a value of the betting time timer becomes “0”. When a value of the betting time timer becomes “0” (that is, when the betting time becomes “0”), the server CPU 49 proceeds to the step S4.

At the step S4, the server CPU 49 outputs a motor driving signal to the motor 8. The motor 8 rotates the rotational shaft 8a according to the motor driving signal. As a result, the rotation plate 5 is rotated, so that the dices 7 are rotated.

At the step S5, the server CPU 49 transmits a reel rotation request signal to each station 10. Each station 10 rotates the reel 44 according to the reel rotation request signal. As a result, the dice symbols 45 drawn on the circumferential face of the reel 44 are scrolled.

At the step S6, the server CPU 49 waits until a prescribed driving period (10 seconds, for example) elapses since outputting the motor driving signal, and proceeds to the step S7 when the driving period has elapsed.

At the step S7, the server CPU 49 outputs a motor stopping signal to the motor 8. The motor 8 stops the rotational shaft 8a according to the motor stopping signal. As a result, the rotation plate 5 is stopped, so that the dices 7 are stopped. As a result, two dice symbols among the three dice symbols for judgment are ascertained.

At the step S8, the server CPU 49 judges a condition that a betting operation signal is given from any one of the stations 10, and proceeds to the step S9 when this condition is satisfied, or finishes the server side processing when this condition is not satisfied. Note that each station 10 outputs the betting operation signal regarding an identification information for distinguishing itself at the other stations 10 and a content of the betting operation to the server CPU 49 when the player made the betting operation at that station 10. Here, the content of the betting operation includes how many medals are bet on which panel by the player, and the number of medals bet on the slot game.

Consequently, the server CPU 49 will carry out the processing of the step S9 and the subsequent steps when the player who is participating in the Sic Bo game or the slot game exists.

At the step S9, the server CPU 49 outputs a scanner driving signal to the scanner 9. The scanner 9 acquires an image in which the lower faces of the dices 7 are drawn by scanning the upper face of the rotation plate 5 almost entirely according to the scanner driving signal. The scanner 9 outputs an image signal regarding the acquired image to the server CPU 49.

At the step S10, the server CPU 49 waits until the image signal is given from the scanner 9, and proceeds to the step S11 when the image signal is given.

At the step S11, the server CPU 49 outputs a reel stopping result request signal to each station 10. Each station 10 outputs a reel stopping result signal regarding an identification information for distinguishing itself from the other stations 10 and a central dice symbol 45 among the rearranged three dice symbols 45 to the server CPU 49, according to the reel stopping result request signal.

At the step S12, the server CPU 49 waits until the reel stopping result signals are given from all the stations 10, and proceeds to the step S13 when the reel stopping result signals are given from all the station 10.

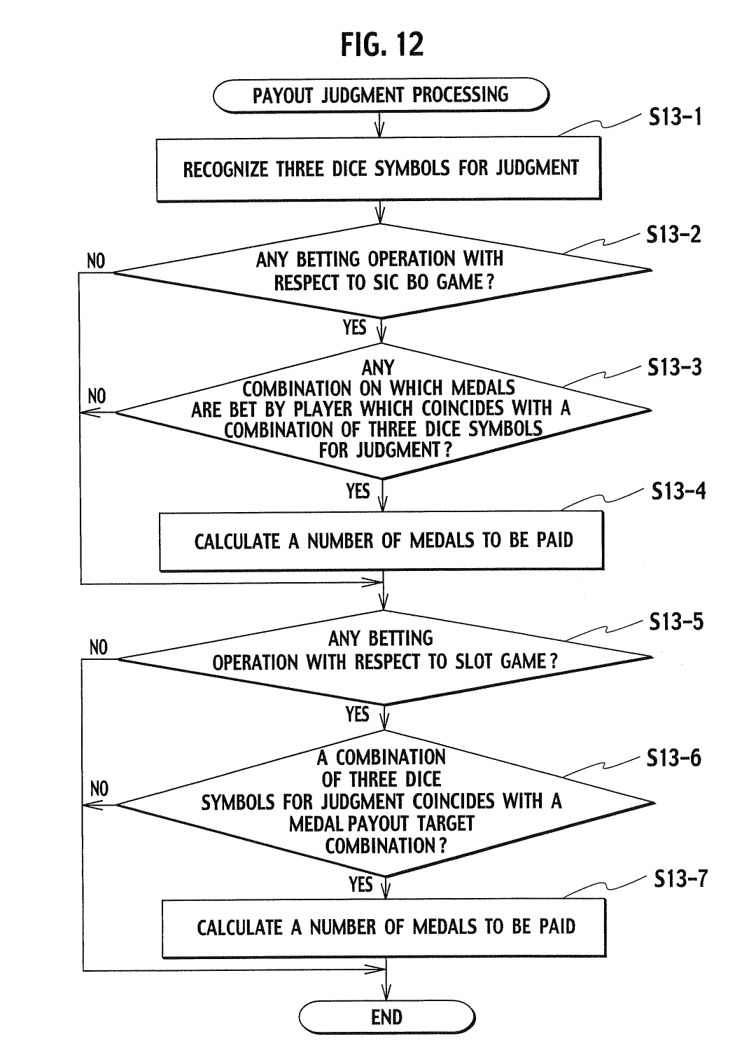

At the step S13, the server CPU 49 carries out a control for determining whether medals are to be paid at one station 10, for each station 10, according to the image signal, the reel stopping result signal and the betting operation signal given from each station 10, and the correspondence table stored in the server ROM 47. More specifically, the server CPU 49 generates a judgment result signal regarding an identification information for distinguishing one station 10 from the other stations 10 and the number of medals to be paid at that one station 10, by carrying out the payout judgment processing shown in FIG. 12.

At the step S14, the server CPU 49 judges the station 10 to be an output target of each judgment result signal according to the identification information among the information indicated by each judgment result signal, and outputs each judgment result signal to the station 10 that is an output target according to that judgment result. After that, the server CPU 49 finishes the server side processing.

FIG. 12 shows a procedure of the payout judgment processing. The server CPU 49 carries out the payout judgment processing for each station 10.

At the step S13-1, the server CPU 49 recognizes the three dice symbols for judgment according to the image signal and the reel stopping result signal given from the one station 10. On the other hand, the server CPU 49 generates a judgment result signal indicating the identification information indicated by the reel stopping result signal given from the one station 10, the number of medals to be paid at that one station 10 in the Sic Bo game, and the number of medals to be paid at that one station 10 in the slot game. Note that, at this point, the judgment result signal has both of the number of medals to be paid at one station 10 in the Sic Bo game and the number of medals to be paid at one station in the slot game set to be “0”.

At the step S13-2, the server CPU 49 judges a condition that the player made the betting operation with respect to the Sic Bo game according to the betting operation signal given from one station 10, and proceeds to the step S13-3 when this condition is satisfied, or proceeds to the step S13-5 when this condition is not satisfied.

At the step S13-3, the server CPU 49 judges a condition that a combination that coincides with the combination of the three dice symbols for judgment exists among combinations on which medals are bet by the player, according to the three dice symbols for judgment, the correspondence table, and the betting operation signal given from one station 10, and proceeds to the step S13-4 when this condition is satisfied, or proceeds to the step S13-5 when this condition is not satisfied.

At the step S13-4, the server CPU 49 calculates a number of medals to be paid at one station 10 in the Sic Bo game, according to the three dice symbols for judgment, the correspondence table, and the betting operation signal given from one station 10. More specifically, the server CPU 49 calculates an integer x1 indicated by the following equation (1) for each combination that satisfies the condition of the step S13-3, and calculates a number of medals to be paid at one station 10 by summing the calculated integers x1. The server CPU 49 replaces the number of medals to be paid at one station 10 in the Sic Bo game within the information indicated by the judgment result signal by that calculated number. After that, the server CPU 49 proceeds to the step S13-5.

x1=(the number of medals bet on a combination that satisfies the condition of the step S13-3)×(the payout rate of that combination) (1)

At the step S13-5, the server CPU 49 judges a condition that the player made the betting operation with respect to the slot game, according to the betting operation signal given from one station 10, and proceeds to the step S13-6 when this condition is satisfied, or finishes the payout judgment processing when this condition is not satisfied.

At the step S13-6, the server CPU 49 judges a condition that the combination of the three dice symbols for judgment coincides with the medal payout target combination, and proceeds to the step S13-7 when this condition is satisfied, or finishes the payout judgment processing.

At the step S13-7, the server CPU 49 calculates a number of medals to be paid at one station 10 in the slot game, according to the correspondence table, the three dice symbols for judgment, and the betting operation signal given from one station 10. More specifically, the server CPU 49 calculates a number of medals to be paid to the player by the following equation (2). The server CPU 49 replaces the number of medals to be paid at one station 10 in the slot game within the information indicated by the judgment result signal by that calculated number. After that, the server CPU 49 finishes the payout judgment processing.

(the number of medals to be paid to the player)=(the number of medals bet on the slot game)×(the payout rate corresponding to the combination of the three dice symbols for judgment) (2)

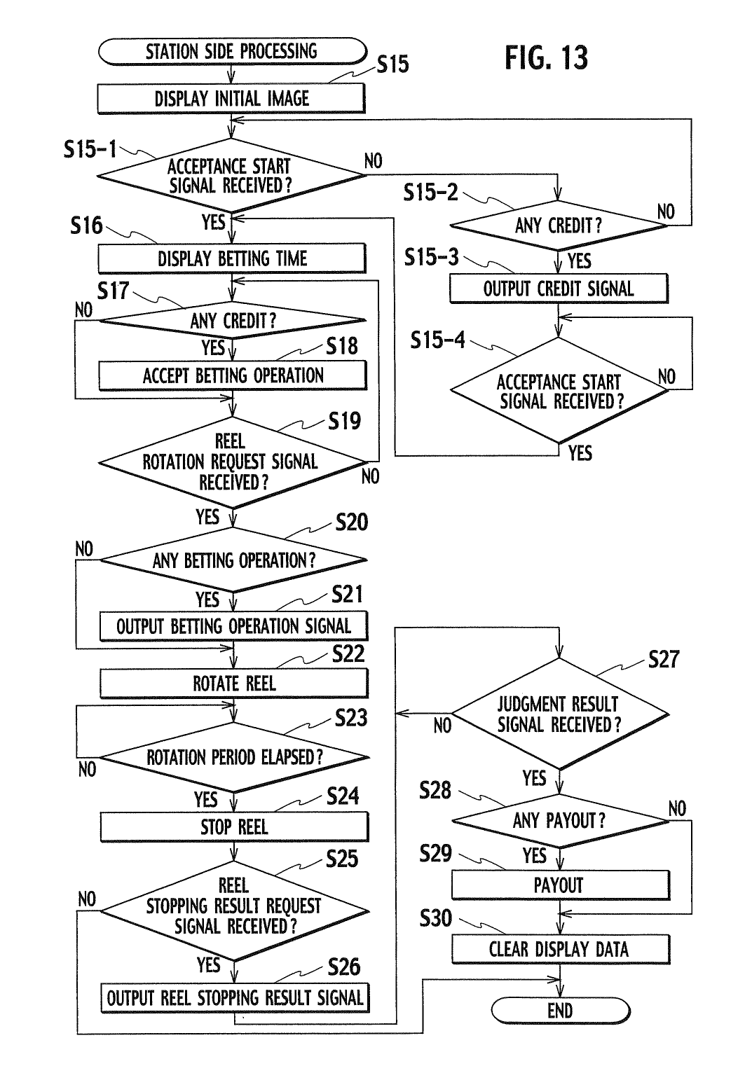

FIG. 13 is a flow chart showing a procedure of the station side processing. At the step S15, the station CPU 56 displays the image shown in FIG. 3 on the liquid crystal display device 13. Note that, inside the credit number display frame 26, a value of a total credit number counter (this counter indicates a total credit number and stored in the station RAM 51, and its initial value is “0”) will be displayed. Note that the value of the total credit number counter may be increased by the credit increasing processing to be described below.

At the step S15-1, the station CPU 56 judges a condition that the acceptance start signal is given, and proceeds to the step S16 when this condition is satisfied, or proceeds to the step S15-2 when this condition is not satisfied.

At the step S16, the station CPU 56 displays “60”, which is an initial value of the betting time, inside the betting time display frame 14. Thereafter, the station CPU 56 decreases a value inside the betting time display frame 14 by one whenever one second elapses, in parallel to the processing of the step S17 to the step S19.

At the step S17, the station CPU 56 judges a condition that a value of the total credit number counter is greater than or equal to 1, and proceeds to the step S18 when this condition is satisfied, or proceeds to the step S19 when this condition is not satisfied.

At the step S18, the station CPU 56 accepts the betting operation. Namely, the station CPU 56 accepts the operation signal given from the touch panel 52, recognizes the content of the betting operation made by the player according to that operation signal, and stores the recognized content as the betting operation information into the station RAM 51. Here, the content of the betting operation includes how many medals are bet on which panel, how many medals are bet on the slot game, etc. The station CPU 56 decreases a value of the total credit number counter according to the betting operation information. In addition, the station CPU 56 updates numerical values displayed inside the betting number display frames 24 and 34 according to the betting operation information.

At the step S19, the station CPU 56 judges a condition that the reel rotation request signal is given from the server CPU 49, and finishes the acceptance of the betting operation and proceeds to the step S20 when this condition is satisfied, or proceeds to the step S17 when this condition is not satisfied.

At the step S15-2, the station CPU 56 judges a condition that a value of the total credit number counter is greater than or equal to 1, and proceeds to the step S15-3 when this condition is satisfied, or proceeds to the step S15-1 when this condition is not satisfied.

At the step S15-3, the station CPU 56 outputs the credit signal to the server CPU 49.

At the step S15-4, the station CPU 56 waits until the acceptance start signal is given from the server CPU 49, and proceeds to the step S16 when the acceptance start signal is given.

Consequently, in the case where at least one station 10 for which the total credit number becomes greater than or equal to 1 exists among the eight stations 10, all the stations 10 will display the betting time simultaneously, and gradually decrease the betting time. On the other hand, the player can make the betting operation at any station 10 until the betting time becomes “0”.

At the step S20, the station CPU 56 judges a condition that the betting operation information is stored in the station RAM 51, that is a condition that the betting operation is made by the player, and proceeds to the step S21 when this condition is satisfied, or proceeds to the step S22 when this condition is not satisfied.

At the step S21, the station CPU 56 outputs the betting operation signal regarding the identification information for distinguishing the own station 10 from the other stations 10 and the betting operation information to the server CPU 49.

At the step S22, the station CPU 56 starts the rotation of the reel 44. At the step S23, the station CPU 56 waits until a prescribed rotation period (10 seconds, for example) elapses since the processing of the step S22 is finished, and proceeds to the step S24 when the prescribed rotation period has elapsed.

At the step S24, the station CPU 56 stops the reel 44. As a result, the three dice symbols 45 are rearranged, so that one dice symbol for judgment among the three dice symbols for judgment is ascertained.

At the step S25, the station CPU 56 judges a condition that the reel stopping result request signal is given from the server CPU 49, and proceeds to the step S26 when this condition is satisfied, or finishes the station side processing when this condition is not satisfied.

At the step S26, the station CPU 56 outputs the reel stopping result signal regarding the identification information for distinguishing the own station 10 from the other stations 10 and the central dice symbol 45 among the rearranged three dice symbols 45 to the server CPU 49.

At the step S27, the station CPU 56 waits until the judgment result signal is given from the server CPU 49, and proceeds to the step S28 when the judgment result signal is given.

At the step S28, the station CPU 56 judges whether a payout of medals is to be made or not according to the judgment result signal, and proceeds to the step S29 when the payout of medals is to be made, or proceeds to the step S30 when the payout of medals is not to be made.

At the step S29, the station CPU 56 recognizes the number of medals to be paid to the player in the Sic Bo game and the number of medals to be paid to the player in the slot game according to the judgment result signal. The station CPU 56 displays the number of medals to be paid to the player in the Sic Bo game inside the acquired medal number display frame 25, and displays the number of medals to be paid to the player in the slot game inside the acquired medal number display frame 35. In addition, the station CPU 56 adds a total of the number of medals to be paid to the player in the Sic Bo game and the number of medals to be paid to the player in the slot game to a value of the total credit number counter, sets a value obtained by this as a new value of the total credit number counter, and displays the new value of the total credit number counter inside the credit number display frame 26.

At the step S30, the station CPU 56 deletes all the chips 151, and displays “0” inside the betting number display frames 24 and 34 and the acquired medal number display frames 25 and 35. In addition, the station CPU 56 deletes unnecessary data (the betting operation information, for example) among data stored in the station RAM 51. Here, however, the value of the total credit number counter will not be deleted. After that, the station CPU 56 finishes the station side processing.

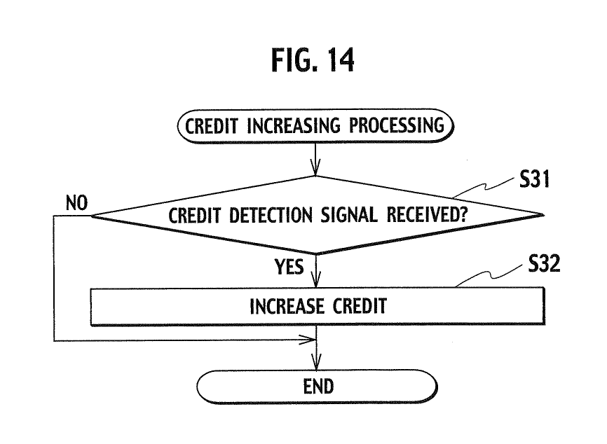

FIG. 14 is a flow chart showing a procedure of the credit increasing processing. The station CPU 56 carries out the credit increasing processing whenever the station side processing is carried out for a prescribed time (1 ms, for example).

At the step S31, the station CPU 56 judges a condition that the credit detection signal is given from the medal sensor 53, and proceeds to the step S32 when this condition is satisfied, or finishes the credit increasing processing when this condition is not satisfied.

At the step S32, the station CPU 56 increases the value of the total credit number counter by “1”. After that, the station CPU 56 finishes the credit increasing processing.

As described above, in the first embodiment, the gaming device 1 provides a new multiple participant type game in which whether medals are to be paid at each station 10 or not is determined according to the two dice symbols for judgment displayed by the dice rotation device 2 and the one dice symbol for judgment rearranged individually at each station 10. In addition, a player cannot judge whether a payout of medals can be received by himself or not unless attentions are paid to both the dice rotation device 2 and the station 10 at which a player himself made the betting operation, so that it is expected to be less likely to get bored by the game compared with the case where it suffices to pay attentions only to the dice rotation device 2 or the case where it suffices to pay attentions only to the station 10 at which a player himself made the betting operation.

In particular, the gaming device 1 provides a new multiple participant type game in which whether medals are to be paid at each station 10 or not is determined according to a combination of the two dice symbols for judgment displayed by the dice rotation device 2 and the one dice symbol for judgment rearranged individually at each station 10. Note that the gaming device 1 may determine whether medals are to be paid at each station 10 or not according to whether how many of a prescribed dice symbol (a dice symbol indicating “1”, for example) are included in the two dice symbols for judgment displayed by the dice rotation device 2 and the one dice symbol for judgment rearranged individually at each station 10.

In addition, the gaming device 1 provides a new multiple participant type game in which medals are paid at a station 10 at which the betting operation is made, when a combination of the two dice symbols for judgment displayed by the dice rotation device 2 and the one dice symbol for judgment rearranged individually at each station 10 coincides with a combination on which the betting operation is made. Namely, a player can enjoy a game for guessing what a combination of the two dice symbols for judgment displayed by the dice rotation device 2 and the one dice symbol for judgment rearranged individually at the station 10 at which the betting operation is made by himself is going to be.

### Second Embodiment

Next, the second embodiment of the present invention will be described. Portions at which the second embodiment is different from the first embodiment are the server side processing and the station side processing, so that these portions will be described.

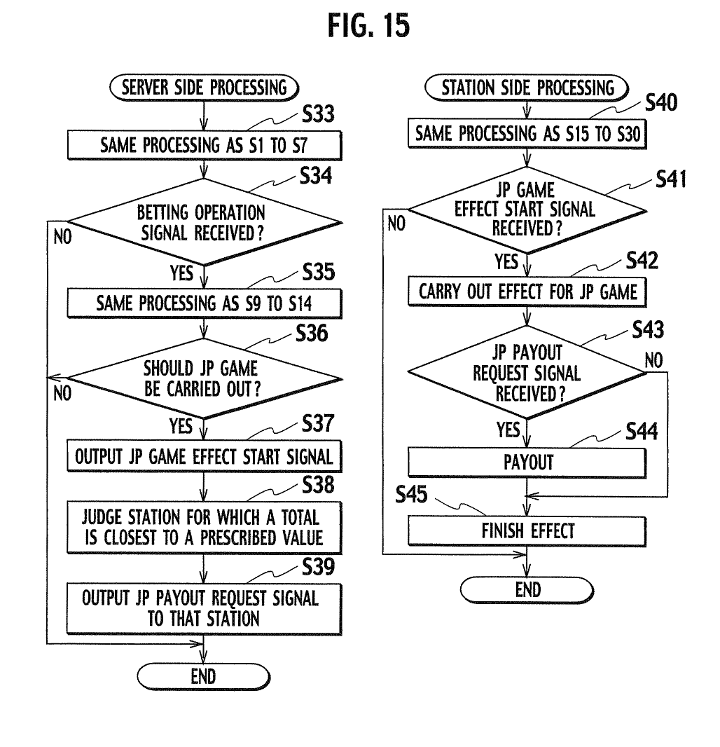

FIG. 15 is a flow chart showing a procedure of the server side processing and the station side processing.

At the step S33, the server CPU 49 carries out the processing of the step S1 to the step S7 shown in FIG. 11.

At the step S34, the server CPU 49 judges a condition that the betting operation signal is given from any one of the stations 10, and proceeds to the step S35 when this condition is satisfied, or finishes the server side processing when this condition is not satisfied.

At the step S35, the server CPU 49 carries out the processing of the step S9 to the step S14 shown in FIG. 11.

At the step S36, the server CPU 49 judges whether a JP (Jackpot) game is to be carried out or not, and proceeds to the step S37 when the JP game is to be carried out, or finishes the server side processing when the JP game is not to be carried out. The JP game in the second embodiment is such that medals will be paid at the station 10 for which a difference between a total of the numerical values indicated by the three dice symbols for judgment and a prescribed value (“21”, for example) is the smallest.

At the step S37, the server CPU 49 outputs a JP game effect start signal to each station 10.

At the step S38, the server CPU 49 judges the station 10 for which the difference between a total of the numerical values indicated by the three dice symbols for judgment and the prescribed value is the smallest.

At the step S39, the server CPU 49 outputs a JP payout request signal to the station 10 judged by the processing of the step S38. After that, the server CPU 49 finishes the server side processing.

On the other hand, at the step S40, the station CPU 56 carries out the processing of the steps S15 to the step S30 shown in FIG. 13.

At the step S41, the station CPU 56 judges a condition that the JP game effect start signal is given from the server CPU 49, and proceeds to the step S42 when this condition is satisfied, or finishes the station side processing when this condition is not satisfied.

At the step S42, the station CPU 56 carries out the effect for the JP game. Here, as the effect for the JP game, it is possible to consider the effect for displaying an image provided in advance for the JP game on the liquid crystal display device 13, the effect for generating effect sounds provided in advance for the JP game, etc.

At the step S43, the station CPU 56 judges a condition that the JP payout request signal is given from the server CPU 49, and proceeds to the step S44 when this condition is satisfied, or proceeds to the step S45 when this condition is not satisfied.

At the step S44, the station CPU 56 pays a prescribed number (“500”, for example) of medals to the player. More specifically, the station CPU 56 increases a value of the total credit number counter by that prescribed number. A value of the total credit number counter after the increase will be displayed inside the credit number display frame 26.

At the step S45, the station CPU 56 finishes the effect for the JP game. After that, the station CPU 56 finishes the station side processing.

As described above, in the second embodiment, the gaming device 1 provides a new multiple participant type game in which medals are paid at the station 10 for which a difference between a total of the numerical values indicated by the three dice symbols for judgment and a prescribed number is the smallest. In addition, even when medals are not paid in the Sic Bo game and the slot game, the JP game is carried out so that it can be expected that the player still has an expectation that medals may be paid in that JP game, and therefore it is expected to be less likely to get bored by the game.

### Third Embodiment

Next, the third embodiment of the present invention will be described. Here, portions at which the third embodiment is different from the first embodiment will be described.

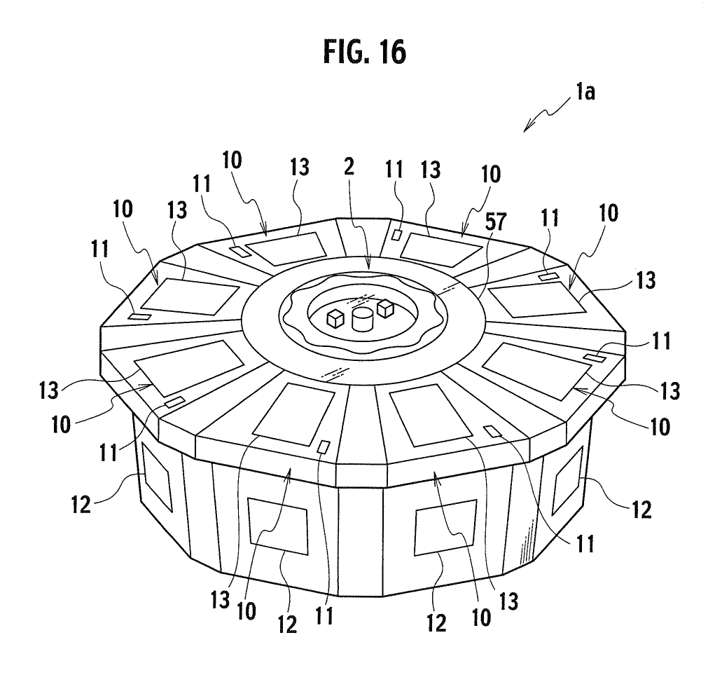

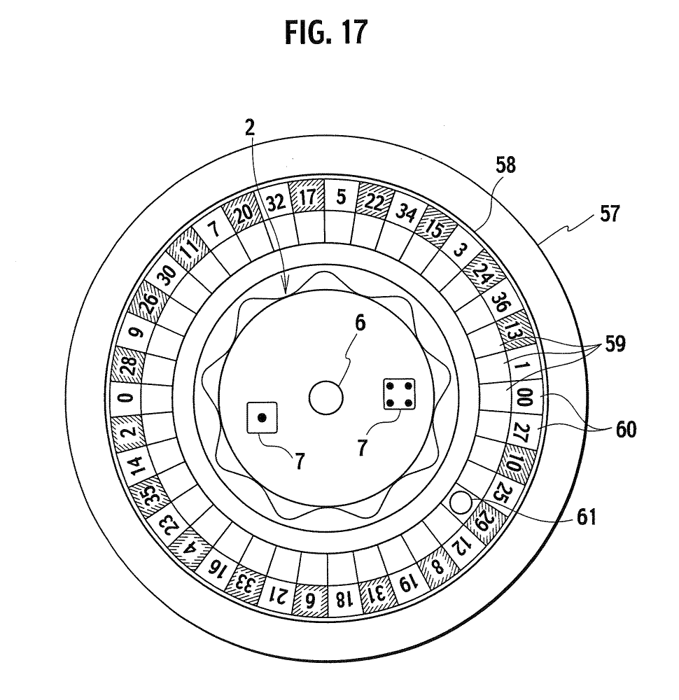

FIG. 16 is an explanatory diagram showing an outward appearance of a gaming device 1a according to the third embodiment, and FIG. 17 is a plan view showing a liquid crystal display device 57.

As shown in FIG. 16, the gaming device 1a is one in which the liquid crystal display device 57 is newly provided in the gaming device 1. The liquid crystal display device 57 is in a ring shape, and provided to surround the dice rotation device 2.

As shown in FIG. 17, the liquid crystal display device 57 displays a roulette wheel 58. The roulette wheel 58 is the so call video roulette wheel, which has a plurality of pockets 59 and a plurality of number plates 60. For each pocket 59, one of the numbers among “00” and “0” to “36” is set. These numbers belong to either a red group or a black group. On outer side of each pocket 59, the number plate 60 is provided. On the number plate 60, one of the numbers among “00” and “0” to “36” is drawn, and it is colored in red or black. (In FIG. 17 and FIG. 18 to FIG. 22 to be described below, colors are indicated by presence or absence of hatching. Namely, black is indicated by presence of hatching, and red is indicated by absence of hatching.) The number drawn on each number plate 60 indicates the number set to the pocket 59 on an inner side of that number plate 60, and the color of each number plate 60 indicates a group to which the number drawn on that number plate 60 belongs.

The roulette wheel 58 is rotated at a prescribed timing, and a ball 61 is launched onto the rotating roulette wheel 58. More specifically, the ball 61 is displayed in any one of the pockets 59. After that, the pocket 59 on which the ball 61 is displayed will be randomly changed. The roulette wheel 58 is stopped after being rotated for a prescribed period since the rotation start, and when the roulette wheel 58 is stopped, the display position of the ball 61 is also fixed. In this way, effectively, the ball 61 is received by one of the pockets 59. In the following, the pocket 59 which received the ball 61 will also be referred to as “a ball receiving pocket”. The gaming device 1a determines whether medals are to be paid at each station 10 or not, according to the number set to the ball receiving pocket, etc.

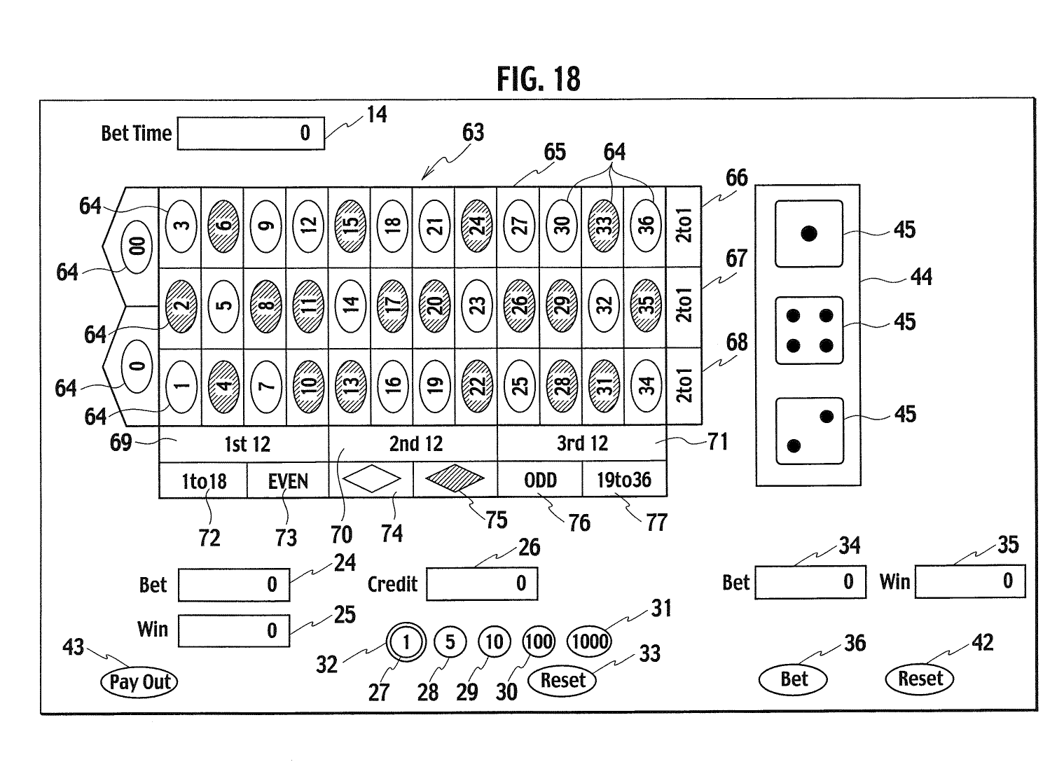

FIG. 18 to FIG. 22 show images to be displayed on the liquid crystal display device 13. The liquid crystal display 13 displays a betting operation panel 63, instead of the betting operation panel 15.

The betting operation panel 63 comprises straight bet panels 64, column bet panels 66 to 68, dozen bet panels 69 to 71, even bet panels 72 to 77, and a frame line 65 which constitutes an outer frame of these panels.

The betting operation panel 63 will be used when the player bets medals with respect to the roulette game. The roulette game is a game in which the player guesses the number of the ball receiving pocket. Namely, the player guesses the number of the ball receiving pocket, and bets medals on the number group that contains the guessed number. When the number of the ball receiving pocket is contained in the number group on which medals are bet, medals will be paid to the played. The operation for betting medals, that is a concrete method for the betting operation will be described below. Note that one roulette game is started as the processing of the step S47 to be described below is started, and finished when all the stations 10 finish the station side processing. A payout rate is set for each of the numbers and the number groups.

On the straight bet panel 64, an ellipse in red or black is drawn, and at a center of that ellipse, one of the numbers among “00” and “0” to “36” is drawn. The color of the ellipse indicates a group to which the number drawn at its center belongs. The number drawn on the straight bet panel 64 corresponds to a number group that contains only that number. For example, the straight bet panel 64 on which “1” is drawn is corresponding to a number group that contains only “1”. The straight bet panel 64 will be used when the player bets medals on the number group that contains a single number. The payout rate set for that number group is 35. In the following description, a vertical direction implies a direction pointed by a straight line that runs along the straight bet panel 64 with “1” drawn thereon and the column bet panel 68, and a horizontal direction implies a direction pointed by a straight line that runs along the straight bet panel 64 with “1” drawn thereon and the straight bet panel 64 with “3” drawn thereon. An upward direction implies a direction pointing from the straight bet panel 64 with “1” drawn thereon to the straight bet panel 64 with “3” drawn thereon, and a downward direction implies a direction pointing from the straight bet panel 64 with “3” drawn thereon to the straight bet panel 64 with “1” drawn thereon.

On the column bet panels 66 to 68, letters “2to1” are drawn. The column bet panel 66 corresponds to a straight bet panel column in the vertical direction that runs along the column bet panel 66 (that is, a column formed by straight bet panels of “3”, “6”, “9” and so on up to “36” (except for the straight bet panel 64 of “00”). Namely, the column bet panel 66 corresponds to a number group comprising all the numbers drawn on that straight bet panel column (that is, a number group comprising “3”, “6”, “9” and so on up to “36”). The column bet panel 66 will be used at a time of betting medals to that number group. The payout rate set for that number group is 2.

The column bet panel 67 corresponds to a straight bet panel column in the vertical direction that runs along the column bet panel 67 (that is, a column formed by straight bet panels of “2”, “5”, “8” and so on up to “35” (except for the straight bet panels 64 of “0” and “00”). Namely, the column bet panel 67 corresponds to a number group comprising all the numbers drawn on that straight bet panel column (that is, a number group comprising “2”, “5”, “8” and so on up to “35”). The column bet panel 67 will be used at a time of betting medals to that number group. The payout rate set for that number group is 2.

The column bet panel 68 corresponds to a straight bet panel column in the vertical direction that runs along the column bet panel 68 (that is, a column formed by straight bet panels of “1”, “4”, “7” and so on up to “34” (except for the straight bet panel 64 of “0”). Namely, the column bet panel 68 corresponds to a number group comprising all the numbers drawn on that straight bet panel column (that is, a number group comprising “1”, “4”, “7” and so on up to “34”). The column bet panel 68 will be used at a time of betting medals to that number group. The payout rate set for that number group is 2.

On the dozen bet panel 69, letters “1st12” are drawn. 1st12 implies “1” to “12”. Consequently, the dozen bet panel 69 corresponds to a number group comprising “1” to “12”, and will be used at a time of betting medals on that number group. The payout rate set for that number group is 2.

On the dozen bet panel 70, letters “2nd12” are drawn. 2nd12 implies “13” to “24”. Consequently, the dozen bet panel 70 corresponds to a number group comprising “13” to “24”, and will be used at a time of betting medals on that number group. The payout rate set for that number group is 2.

On the dozen bet panel 71, letters “3rd12” are drawn. 3rd12 implies “25” to “36”. Consequently, the dozen bet panel 71 corresponds to a number group comprising 25″ to “36”, and will be used at a time of betting medals on that number group. The payout rate set for that number group is 2.

On the even bet panel 72, letters “1to18” are drawn. 1to18 implies “1” to “18”. Consequently, the even bet panel 72 corresponds to a number group comprising “1” to “18”, and will be used at a time of betting medals on that number group. The payout rate set for that number group is 1.

On the even bet panel 73, letters “EVEN” are drawn. EVEN implies “even numbers”. Consequently, the even bet panel 73 corresponds to a number group comprising all the “even numbers”, and will be used at a time of betting medals on that number group. The payout rate set for that number group is 1.

On the even bet panel 74, a red rhomb is drawn. Consequently, the even bet panel 74 corresponds to a number group comprising all the numbers belonging to the red group, and will be used at a time of betting medals on that number group. The payout rate set for that number group is 1.

On the even bet panel 75, a black rhomb is drawn. Consequently, the even bet panel 75 corresponds to a number group comprising all the numbers belonging to the black group, and will be used at a time of betting medals on that number group. The payout rate set for that number group is 1.

On the even bet panel 76, letters “ODD” are drawn. ODD implies “odd numbers”. Consequently, the even bet panel 76 corresponds to a number group comprising all the “odd numbers”, and will be used at a time of betting medals on that number group. The payout rate set for that number group is 1.

On the even bet panel 77, letters “19to36” are drawn. 19to36 implies “19” to “36”. Consequently, the even bet panel 77 corresponds to a number group comprising “19” to “36”, and will be used at a time of betting medals on that number group. The payout rate set for that number group is 1.

Now, there are various other number groups on which the player can bet medals besides those described above, and the frame line 65 will be used at a time of betting medals on these other number groups.

Namely, within the frame line 65, a part constituting a border line between two neighboring straight bet panels 64 (the straight bet panel of “3” and the straight bet panel of “6”, for example) corresponds to a number group comprising the numbers drawn on these two straight bet panels 64, and will be used at a time of betting medals on that number group. The payout rate set for that number group is 17.

Within the frame line 65, the frame line 65 that runs along an upper edge of a straight panel column in the horizontal direction (a straight bet panel column comprising the straight bet panels 64 of “1”, “2” and “3”, for example, and such a panel column will also be referred to as a “straight bet panel column” in the following) corresponds to a number group comprising all the numbers drawn on that straight bet panel column, and will be used at a time of betting medals on that number group. The payout rate set for that number group is 11.

Within the frame line 65, an upper edge portion of the frame line 65 that runs between two neighboring straight panel columns (a straight bet panel column of “1”, “2” and “3” and a straight bet panel column of “4”, “5” and “6”, for example) corresponds to a number group comprising all the numbers drawn on these two straight bet panel columns, and will be used at a time of betting medals on that number group. The payout rate set for that number group is 5.

Note that it is also possible to bet medals on various number groups other than these, but their description will be omitted here.

Inside the betting number display frame 24, a total number of medals bet with respect to the roulette game will be displayed. Inside the acquired medal number display frame 25, a total number of medals newly acquired by the player in the current roulette game will be displayed.

The betting unit determination buttons 27 to 31 will be used at a time of setting the number of medals to be bet with respect to the roulette game or the slot game by a single betting operation (referred also as “a unit betting number of medals” in the following). The numerical values drawn on the betting unit determination buttons 27 to 31 indicate a unit betting number of medals that can be set by pressing that button. For example, the player sets the unit betting number of medals to “1” by pressing the betting unit determination button 27. Note that, the unit betting number of medals is set to “1” in the initial state. The reset button 33 will be used when the player cancels the betting operation with respect to the roulette game.

FIG. 18 shows a screen displayed by each liquid crystal display device 13 when the medals are not entered at all the stations 10 (namely, when “0” is displayed inside all the credit number display frames 26).

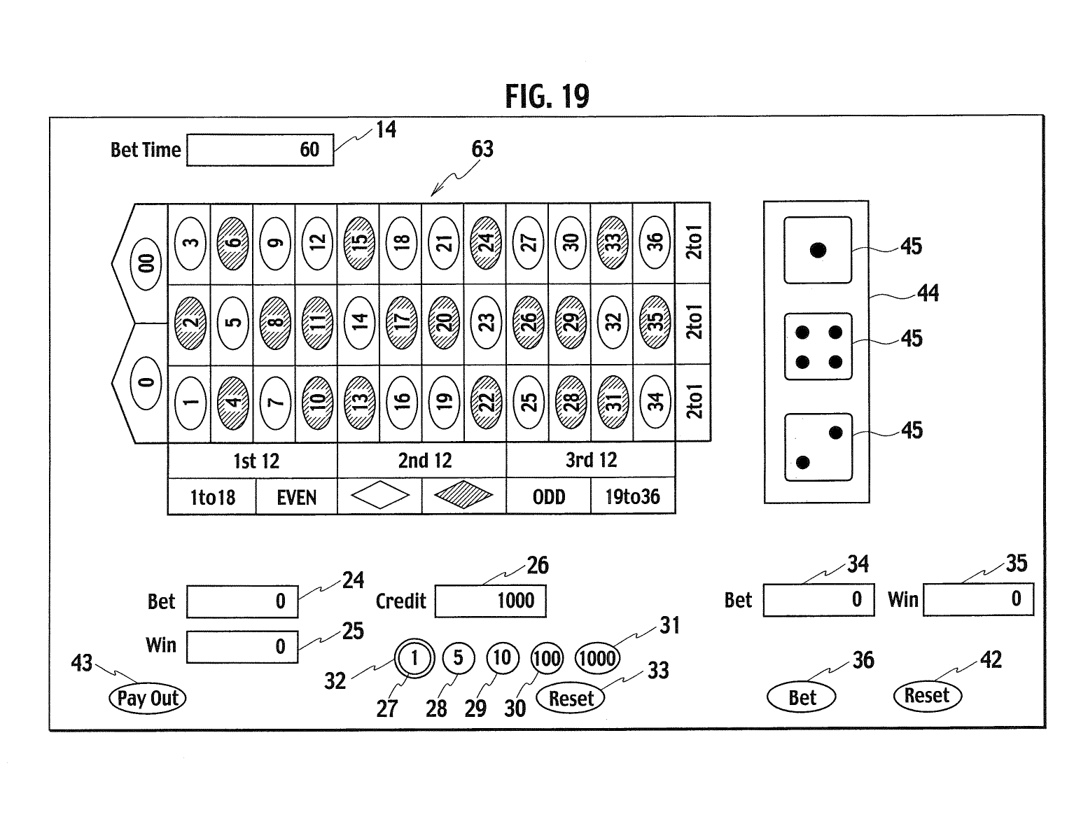

When the medals are not entered at all the stations 10, if the player enters 1000 medals from a medal insertion slot 11 of any station 10, a screen shown in FIG. 19 will be displayed at the liquid crystal display device 13 of that station 10. Namely, “1000” will be displayed inside the credit number display frame 26, and “60” will be displayed inside the betting time display frame 14. After that, the numerical value inside the betting time display frame 14, that is the betting time, is decreased by one whenever one second elapses, so that the player makes the betting operation before the betting time becomes “0”.

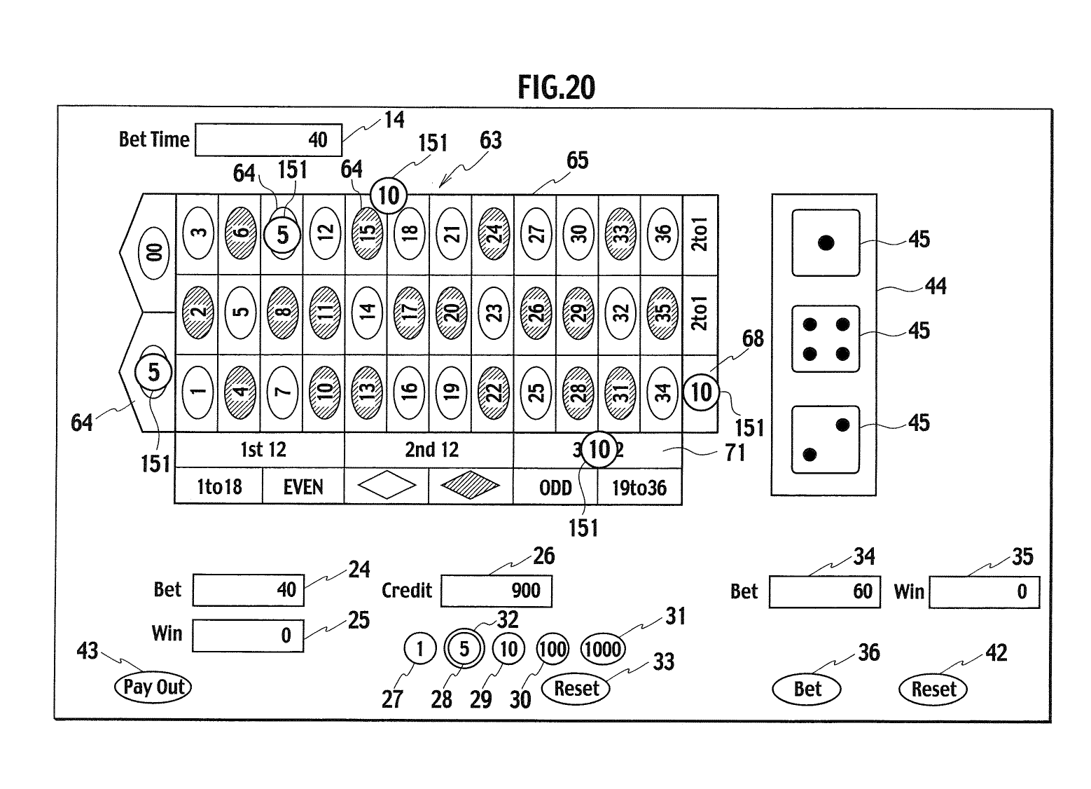

Here, the method of the betting operation will be described according to FIG. 20. The player makes the betting operation with respect to the roulette game by pressing any one panel or the frame line 65 among the panels and the frame line 65 constituting the betting operation panel 63. More specifically, the player guesses the number of the ball receiving pocket, and determines the number group on which medals are desired to be bet according to a result of guessing. The player presses a panel or the frame line 65 corresponding to that determined number group within the betting operation panel 63. As a result, the medals will be bet with respect to that panel or the frame line 65 (namely, the betting operation is made with respect to the number group of his own determination). On the panel or the frame line 65 on which the medals are bet, a chip 151 will be displayed. A numerical value is displayed at a center of the chip 151, and this numerical value indicates a total number of medals bet on the panel or the frame line 65 on which the chip 151 is displayed. The numerical value displayed on the chip 151 is increased as much as the unit betting number of medals currently set, every time the player presses the panel once. The total number of medals bet with respect to the roulette game will be displayed inside the betting number display frame 24. When the reset button 33 is pressed, the total credit number is increased as much as the numerical value displayed inside the betting number display frame 24 until then, the chips 151 are all deleted, and “0” will be displayed inside the betting number display frame 24 (namely, the number of medals bet with respect to the roulette game becomes “0”).

In FIG. 20, 5 medals are bet on the number group of “0”, 5 medals are bet on the number group of “9”, 10 medals are bet on the number group of “13” to “18”, 10 medals are bet on the number group of “1”, “4”, “7” and so on up to “34”, and 10 medals are bet on the number group of “25” to “36”. In this case, the total number of medals bet with respect to the roulette game is “40”, so that this numerical value will be displayed inside the betting number display frame 24.

On the other hand, the player makes the betting operation with respect to the slot game by pressing the bet button 36. Namely, the player can bet medals with respect to the slot game by pressing the bet button 36. The number of medals that are bet with respect to the slot game will be increased as much as the unit betting number of medals currently set, every time the player presses the bet button 36 once. The total number of medals bet with respect to the slot game will be displayed inside the betting number display frame 34. In FIG. 20, 60 medals are bet with respect to the slot game.

The total credit number is decreased as much as a total of the number of medals bet on the roulette game and the number of medals bet on the slot game. In FIG. 20, the total credit number (that is, the numerical value displayed inside the credit number display frame 26) is “1000” initially, but 40 medals are bet on the Sic Bo game and 60 medals are bet on the slot game, so that the total credit number is decreased by “100” and becomes “900”.

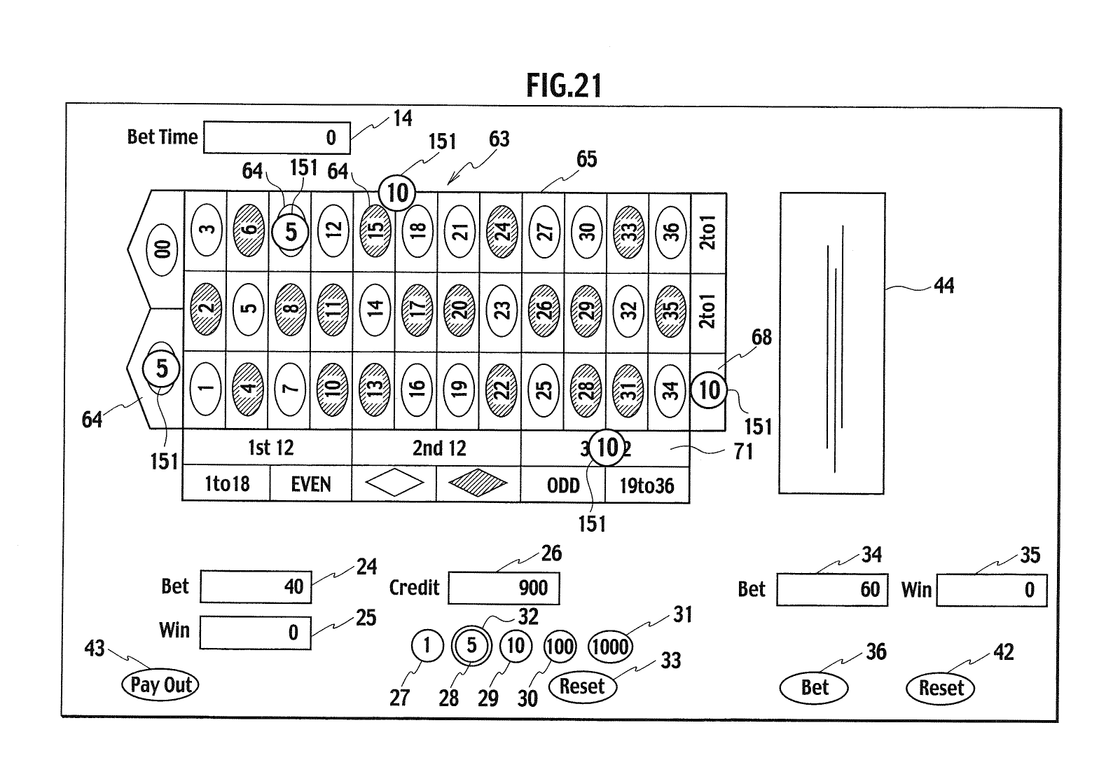

After that, when the betting time becomes “0”, the acceptance of the betting operation is finished, and the rotation of the reel 44 is started. A manner by which the reel 44 rotates is shown in FIG. 21. On the other hand, the dice rotation device 2 starts the rotation of the dices 7, and the liquid crystal display device 57 displays the rotating roulette wheel 58 and the ball 61 launched onto the roulette wheel 58.

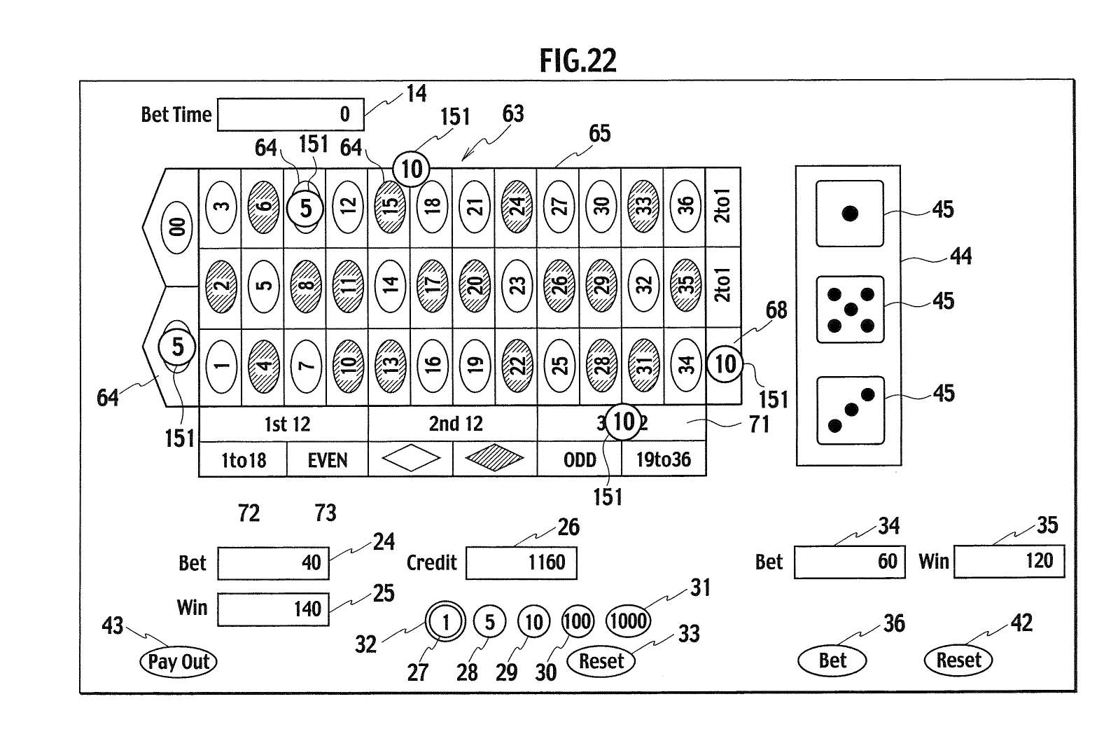

When a certain period of time elapses from the state shown in FIG. 21, the reel 44 is stopped, the dice rotation device 2 stops the rotation of the dices 7, and the liquid crystal display device 57 displays the stopped roulette wheel 58 and the ball 61 received by one of the pockets 59. As a result, the three dice symbols for judgment and the ball receiving pocket are ascertained. A manner by which the reel 44 stops is shown in FIG. 22. In this figure, the dices 7 and the roulette wheel 58 are not shown, but a combination of the three dice symbols for judgment is “5”, “5” and “3”, and the number of the ball receiving pocket is “13”.

After that, if the number of the ball receiving pocket is contained in the number group on which the player bet medals, the player newly acquires medals as much as (the number of medals bet on the number group by the player)×(the payout rate set for that number group) in the roulette game.

On the other hand, if the number of the ball receiving pocket is contained in the number group on which the player bet medals and the number of the ball receiving pocket coincides with a total of the numerical values indicated by the three dice symbols for judgment, the player newly acquires medals as much as (the number of medals bet on the number group by the player)×(the payout rate set for that number group)×2 in the roulette game. The number of medals newly acquired by the player in the roulette game will be displayed inside the acquired medal number display frame 25.

In addition, if the combination of the three dice symbols for judgment coincides with the medal payout target combination, the player newly acquires medals as much as (the number of medals bet with respect to the slot game by the player)×(the payout rate set for the medal payout target combination) in the slot game. The number of medals newly acquired by the player in the slot game will be displayed inside the acquired medal display frame 35.

In an example shown in FIG. 20, the number group of “13” to “18” and the number group of “1”, “4”, “7” and so on up to “34” include the number of the ball receiving pocket which is “13”. Moreover, the total of the numerical value indicated by the three dice symbols for judgment is “13”. Consequently, the player newly acquires 10×5×2+10×2×2=140 medals in the roulette game. This value will be displayed inside the acquired medal number display frame 25.

In addition, the combination of “5”, “5” and “3” is the medal payout target combination in the slot game, and its payout rate is 2, so that the player newly acquires 60×2=120 medals in the slot game. Consequently, “120” will be displayed inside the acquired medal number display frame 35.

After that, the total credit number is increased as much as the total number of medals newly acquired in the roulette game and the slot game by the player. In the case sown in FIG. 22, the total credit number is increased by “260” from “900” and becomes “1160”.

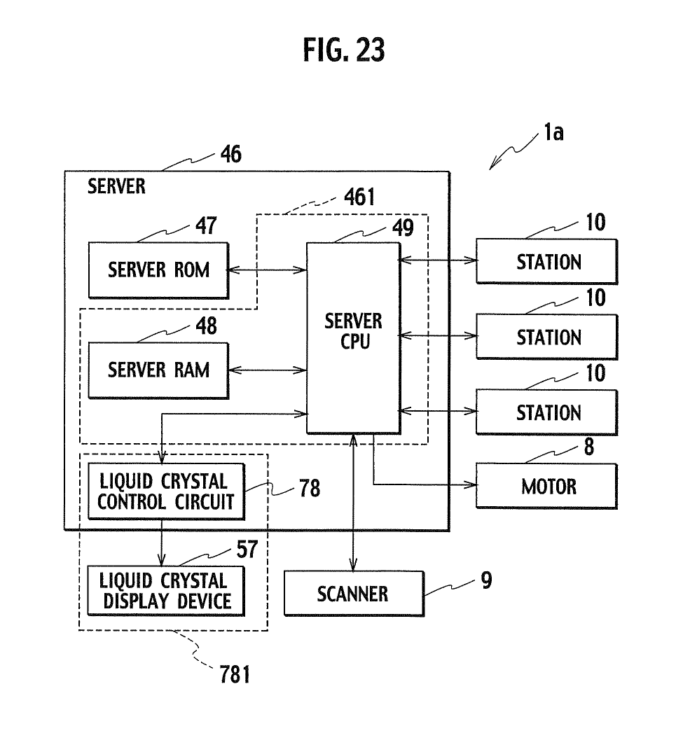

FIG. 23 is a block diagram showing an electric configuration of the gaming device 1a. The gaming device 1a has a server 46 and a plurality of stations 10.

The server 46 has a server ROM 47, a server RAM 48, a server CPU 49, and a liquid crystal control circuit 78, as its electric configuration. A controller 461 is formed by the server RAM 48 and the server CPU 49. A roulette gaming device 781 is formed by the liquid crystal control circuit 78 and the liquid crystal display device 57.

The server ROM 47 stores programs necessary for the operations of the server 46, a correspondence table indicating a correspondence relationship between the number groups and the medal payout target combination and the payout rates, etc. The server RAM 48 will be used as a work area of the server CPU 49.

The server CPU 49 carries out various types of control according to the programs stored in the server ROM 47. For example, the server CPU 49 carries out a control for determining whether medals are to be paid at each station 10 or not, according to the number of the ball receiving pocket, the combinations of the three dice symbols for judgment, and the content of the betting operation. In addition, the server CPU 49 also carries out a control of the liquid crystal control circuit 78, the motor 8 and the scanner 9, and transmission and reception of signals among the stations 10. The liquid crystal control circuit 78 stores images of the roulette wheel 58 and the ball 61, and displays the roulette wheel 58 and the ball 61 on the liquid crystal display device 57 under the control by the server CPU 49.

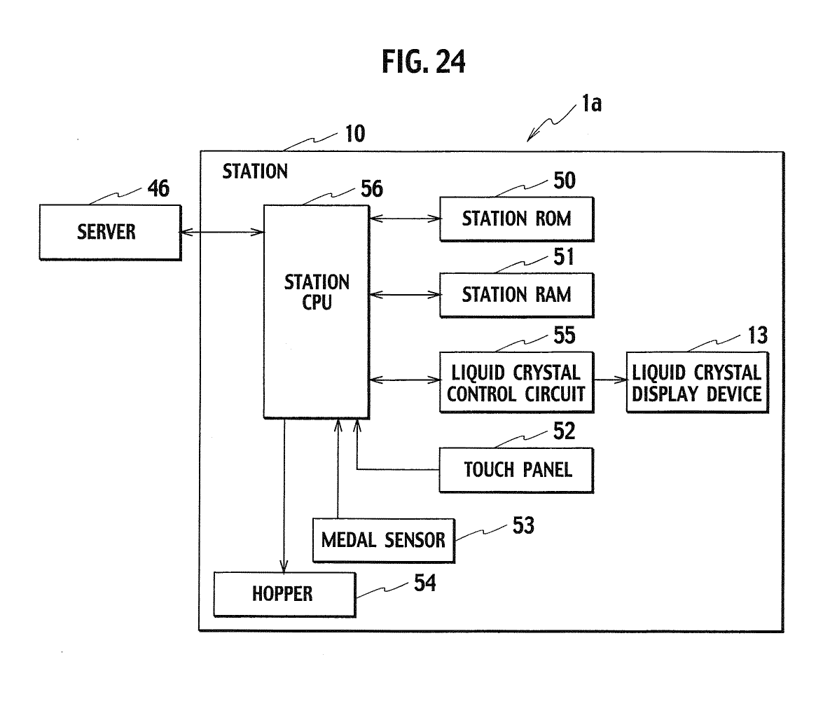

FIG. 24 is a block diagram showing an electric configuration of the station 10. The station 10 has a station ROM 50, a station RAM 51, a touch panel 52, a medal sensor 53, a hopper 54, a liquid crystal control circuit 55, and a liquid crystal display device 13, as its electric configuration. These constituent elements are the same as in the first embodiment, so that their description will be omitted.

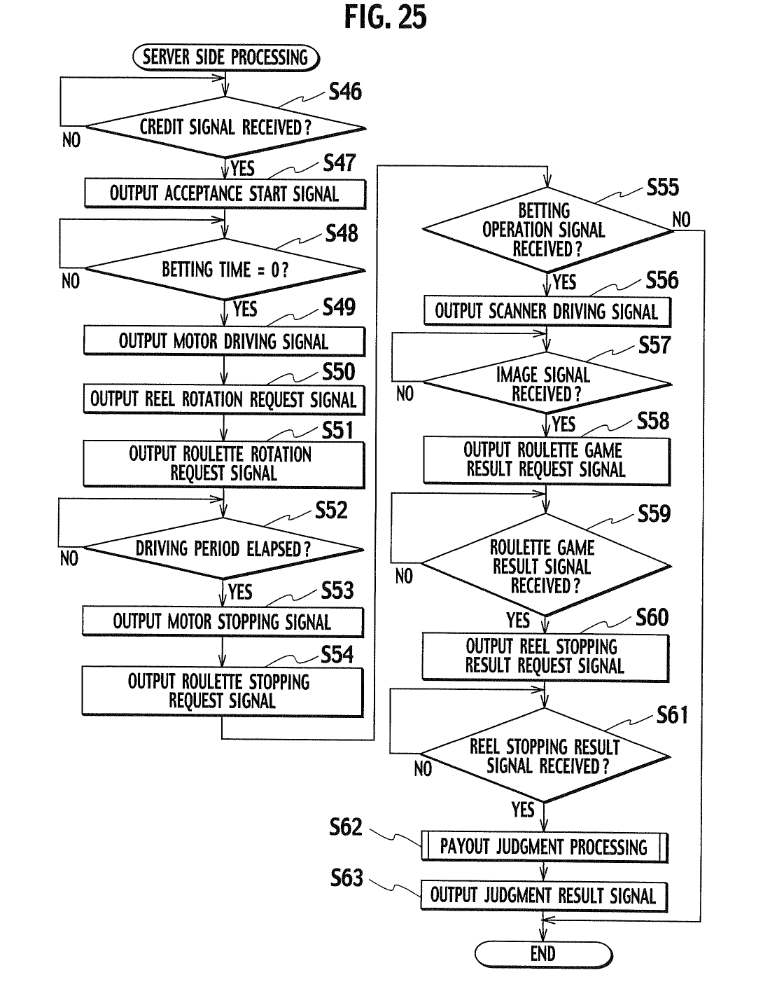

FIG. 25 to FIG. 27 are flow charts showing a procedure of the processing to be carried out by the gaming device 1a. The server 46 carries out the server side processing and the payout judgment processing, and the station 10 carries out the station side processing and the credit increasing processing described above. First, the server side processing will be described.

At the step S46, the server CPU 49 waits until the credit signal is given from any one of the stations 10, and proceeds to the step S47 when the credit signal is given. Note that each station 10 outputs the credit signal to the server CPU 49 when the total credit number stored by that station 10 becomes greater than or equal to 1.

At the step S47, the server CPU 49 outputs an acceptance start signal to each station 10. Each station 10 displays “60”, which is an initial value of the betting time, inside the betting time display frame 14, at a timing of receiving the acceptance start signal, and thereafter, decreases the betting time by one whenever one second elapses. The player can make the betting operation at each station 10 until the betting time becomes “0”.

At the step S48, the server CPU 49 forms a betting time timer in the server RAM 48, and sets its initial value to be “60”. The server CPU 49 thereafter decreases a value of the betting time timer by one whenever one second elapses, and waits until a value of the betting time timer becomes “0”. When a value of the betting time timer becomes “0” (that is, when the betting time becomes “0”), the server CPU 49 proceeds to the step S49.

At the step S49, the server CPU 49 outputs a motor driving signal to the motor 8. The motor 8 rotates the rotational shaft 8a according to the motor driving signal. As a result, the rotation plate 5 is rotated, so that the dices 7 are rotated.

At the step S50, the server CPU 49 transmits a reel rotation request signal to each station 10. Each station 10 rotates the reel 44 according to the reel rotation request signal. As a result, the dice symbols 45 drawn on the circumferential face of the reel 44 are scrolled.

At the step S51, the server CPU 49 outputs a roulette rotation request signal to the liquid crystal control circuit 78. The liquid crystal control circuit 78 displays the roulette wheel 58 on the liquid crystal display device 57 and rotates the roulette wheel 58 according to the roulette rotation request signal.

At the step S52, the server CPU 49 waits until a prescribed driving period elapses since the processing of the step S51 is finished, and proceeds to the step S53 when the driving period has elapsed. Note that the liquid crystal control circuits 78 launches the ball 61 onto the roulette wheel 58 while the server CPU 49 is carrying out the processing of the step S52. More specifically, the liquid crystal control circuit 78 displays the ball 61 at one of the pockets 59. In addition, the liquid crystal control circuit 78 randomly changes the pocket 59 at which the ball 61 is displayed.

At the step S53, the server CPU 49 outputs a motor stopping signal to the motor 8. The motor 8 stops the rotational shaft 8a according to the motor stopping signal. As a result, the rotation plate 5 is stopped, so that the dices 7 are stopped. As a result, two dice symbols among the three dice symbols for judgment are ascertained.

At the step S54, the server CPU 49 outputs a roulette stopping request signal to the liquid crystal control circuit 78. The liquid crystal control circuit 78 stops the roulette wheel 58 and fixes a display position of the ball 61 according to the roulette stopping request signal. As a result, the ball receiving pocket is ascertained.

At the step S55, the server CPU 49 judges a condition that a betting operation signal is given from any one of the stations 10, and proceeds to the step S56 when this condition is satisfied, or finishes the server side processing when this condition is not satisfied. Note that each station 10 outputs the betting operation signal regarding an identification information for distinguishing itself from the other stations 10 and a content of the betting operation to the server CPU 49 when the player made the betting operation at that station 10. Here, the content of the betting operation includes how many medals are bet on which number group by the player, and the number of medals bet on the slot game.

Consequently, the server CPU 49 will carry out the processing of the step S56 and the subsequent steps when the player who is participating in the roulette game or the slot game exists.

At the step S56, the server CPU 49 outputs a scanner driving signal to the scanner 9. The scanner 9 acquires an image in which the lower faces of the dices 7 are drawn by scanning the upper face of the rotation plate 5 almost entirely according to the scanner driving signal. The scanner 9 outputs an image signal regarding the acquired image to the server CPU 49.

At the step S57, the server CPU 49 waits until the image signal is given from the scanner 9, and proceeds to the step S58 when the image signal is given.

At the step S58, the server CPU 49 outputs a roulette game result request signal to the liquid crystal control circuit 78. The liquid crystal control circuit 78 outputs a roulette game result signal regarding the number of the ball receiving pocket to the server CPU 49 according to the roulette game result request signal.

At the step S59, the server CPU 49 was until the roulette game result signal is given, and proceeds to the step S60 when the roulette game result signal is given.

At the step S60, the server CPU 49 outputs a reel stopping result request signal to each station 10. Each station 10 outputs a reel stopping result signal regarding an identification information for distinguishing itself from the other stations 10 and a central dice symbol 45 among the rearranged three dice symbols 45 to the server CPU 49, according to the reel stopping result request signal.

At the step S61, the server CPU 49 waits until the reel stopping result signals are given from all the stations 10, and proceeds to the step S62 when the reel stopping result signals are given from all the station 10.

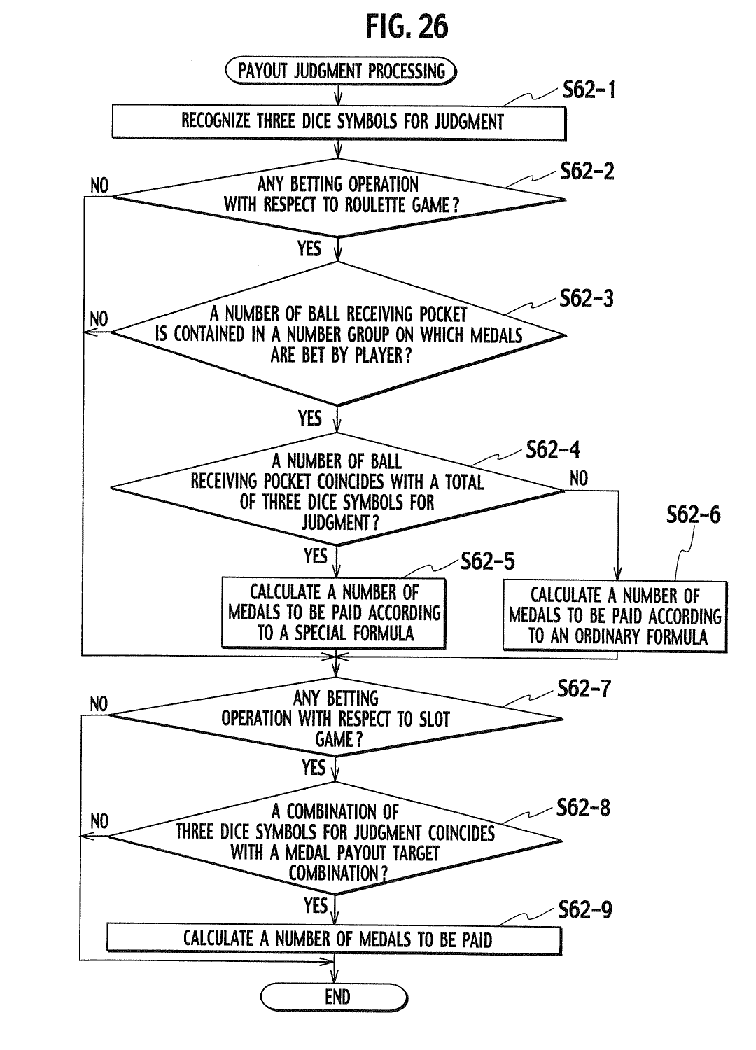

At the step S62, the server CPU 49 carries out a control for determining whether medals are to be paid at one station 10, for each station 10, according to the image signal, the roulette game result signal, the reel stopping result signal and the betting operation signal given from each station 10, and the correspondence table stored in the server ROM 47. More specifically, the server CPU 49 generates a judgment result signal regarding an identification information for distinguishing one station 10 from the other stations 10 and the number of medals to be paid at that one station 10, for each station 10, by carrying out the payout judgment processing shown in FIG. 26.

At the step S63, the server CPU 49 judges the station 10 to be an output target of each judgment result signal according to the identification information among the information indicated by each judgment result signal, and outputs each judgment result signal to the station 10 that is an output target according to that judgment result.

After that, the server CPU 49 finishes the server side processing.

FIG. 26 shows a procedure of the payout judgment processing. The server CPU 49 carries out the payout judgment processing for each station 10.

At the step S62-1, the server CPU 49 recognizes the three dice symbols for judgment according to the image signal and the reel stopping result signal given from the one station 10. On the other hand, the server CPU 49 generates a judgment result signal indicating the identification information indicated by the reel stopping result signal given from the one station 10, the number of medals to be paid at that one station 10 in the roulette game, and the number of medals to be paid at that one station 10 in the slot game. Note that, at this point, the judgment result signal has both of the number of medals to be paid at one station 10 in the roulette game and the number of medals to be paid at one station in the slot game set to be “0”.

At the step S62-2, the server CPU 49 judges a condition that the player made the betting operation with respect to the roulette game according to the betting operation signal given from one station 10, and proceeds to the step S62-3 when this condition is satisfied, or proceeds to the step S62-7 when this condition is not satisfied.

At the step S62-3, the server CPU 49 judges a condition that the number of the ball receiving pocket is contained in the number group on which the player bet medals, according to the betting operation signal given from one station 10 and the roulette game result signal, and proceeds to the step S62-4 when this condition is satisfied, or proceeds to the step S62-7 when this condition is not satisfied.

At the step S62-4, the server CPU 49 judges a condition that the number of the ball receiving pocket coincides with a total of the numerical values indicated by the three dice symbols for judgment, according to the roulette game result signal and the three dice symbols for judgment, and proceeds to the step S62-5 when this condition is satisfied, or proceeds to the step S62-6 when this condition is not satisfied.

At the step S62-5, the server CPU 49 calculates a number of medals to be paid at one station 10 in the roulette game, according to the three dice symbols for judgment, the correspondence table, and the betting operation signal given from one station 10. More specifically, the server CPU 49 calculates an integer x2 indicated by the following equation (3) for each number group that satisfies the condition of the step S62-3, and calculates a number of medals to be paid at one station 10 by summing the calculated integers x2. The server CPU 49 replaces the number of medals to be paid at one station 10 in the roulette game within the information indicated by the judgment result signal by that calculated number. After that, the server CPU 49 proceeds to the step S62-7.

x2=(the number of medals bet on a number group that satisfies the condition of the step S62-3)×(the payout rate of that number group)×2 (3)

At the step S62-6, the server CPU 49 calculates a number of medals to be paid at one station 10 in the roulette game, according to the correspondence table and the betting operation signal given from one station 10. More specifically, the server CPU 49 calculates an integer x3 indicated by the following equation (4) for each number group that satisfies the condition of the step S62-3, and calculates a number of medals to be paid at one station 10 by summing the calculated integers x3. The server CPU 49 replaces the number of medals to be paid at one station 10 in the roulette game within the information indicated by the judgment result signal by that calculated number. After that, the server CPU 49 proceeds to the step S62-7.

x3=(the number of medals bet on a number group that satisfies the condition of the step S62-3)×(the payout rate of that number group) (4)

At the step S62-7, the server CPU 49 judges a condition that the player made the betting operation with respect to the slot game according to the betting operation signal, and proceeds to the step S62-8 when this condition is satisfied, or finishes the payout judgment processing when this condition is not satisfied.

At the step S62-8, the server CPU 49 judges a condition that the combination of the three dice symbols for judgment coincides with the medal payout target combination, and proceeds to the step S62-9 when this condition is satisfied, or finishes the payout judgment processing.

At the step S62-9, the server CPU 49 calculates a number of medals to be paid at one station 10 in the slot game, according to the correspondence table, the three dice symbols for judgment, and the betting operation signal given from one station 10. More specifically, the server CPU 49 calculates a number of medals to be paid to the player by the equation (2) described above. The server CPU 49 replaces the number of medals to be paid at one station 10 in the slot game within the information indicated by the judgment result signal by that calculated number. After that, the server CPU 49 finishes the payout judgment processing.

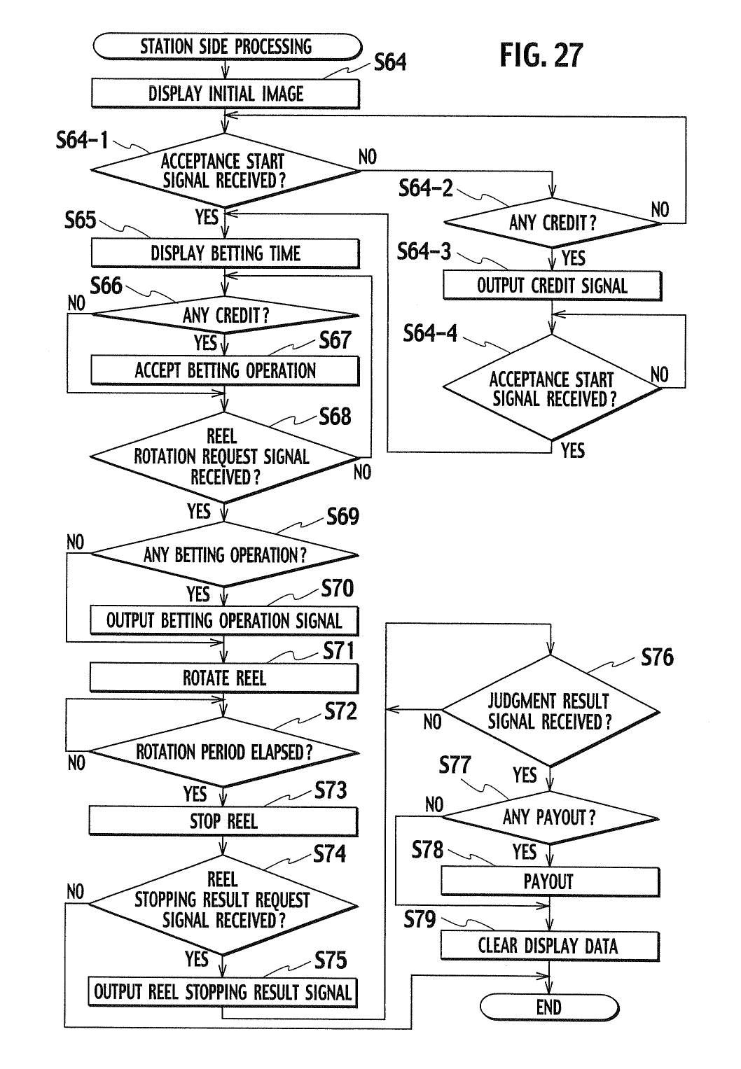

FIG. 27 is a flow chart showing a procedure of the station side processing. At the step S64, the station CPU 56 displays the image shown in FIG. 18 on the liquid crystal display device 13. Note that, inside the credit number display frame 26, a value of a total credit number counter will be displayed.

At the step S64-1, the station CPU 56 judges a condition that the acceptance start signal is given, and proceeds to the step S65 when this condition is satisfied, or proceeds to the step S64-2 when this condition is not satisfied.

At the step S65, the station CPU 56 displays “60”, which is an initial value of the betting time, inside the betting time display frame 14. Thereafter, the station CPU 56 decreases a value inside the betting time display frame 14 by one whenever one second elapses, in parallel to the processing of the step S66 to the step S68.

At the step S66, the station CPU 56 judges a condition that a value of the total credit number counter is greater than or equal to 1, and proceeds to the step S67 when this condition is satisfied, or proceeds to the step S68 when this condition is not satisfied.

At the step S67, the station CPU 56 accepts the betting operation. Namely, the station CPU 56 accepts the operation signal given from the touch panel 52, recognizes the content of the betting operation made by the player according to that operation signal, and stores the recognized content as the betting operation information into the station RAM 51. Here, the content of the betting operation includes how many medals are bet on which number group, how many medals are bet on the slot game, etc. The station CPU 56 decreases a value of the total credit number counter according to the betting operation information. In addition, the station CPU 56 updates numerical values displayed inside the betting number display frames 24 and 34 according to the betting operation information.

At the step S68, the station CPU 56 judges a condition that the reel rotation request signal is given from the server CPU 49, and finishes the acceptance of the betting operation and proceeds to the step S69 when this condition is satisfied, or proceeds to the step S66 when this condition is not satisfied.

At the step S64-2, the station CPU 56 judges a condition that a value of the total credit number counter is greater than or equal to 1, and proceeds to the step S64-3 when this condition is satisfied, or proceeds to the step S64-1 when this condition is not satisfied.

At the step S64-3, the station CPU 56 outputs the credit signal to the server CPU 49.

At the step S64-4, the station CPU 56 waits until the acceptance start signal is given from the server CPU 49, and proceeds to the step S65 when the acceptance start signal is given.

At the step S69, the station CPU 56 judges a condition that the betting operation information is stored in the station RAM 51, that is a condition that the betting operation is made by the player, and proceeds to the step S70 when this condition is satisfied, or proceeds to the step S71 when this condition is not satisfied.

At the step S70, the station CPU 56 outputs the betting operation signal regarding the identification information for distinguishing the own station 10 from the other stations 10 and the betting operation information to the server CPU 49.

At the step S71, the station CPU 56 starts the rotation of the reel 44. At the step S72, the station CPU 56 waits until a prescribed rotation period (10 seconds, for example) elapses since the processing of the step S71 is finished, and proceeds to the step S73 when the prescribed rotation period has elapsed.

At the step S73, the station CPU 56 stops the reel 44. As a result, the three dice symbols 45 are rearranged, so that one dice symbol for judgment among the three dice symbols for judgment is ascertained.

At the step S74, the station CPU 56 judges a condition that the reel stopping result request signal is given from the server CPU 49, and proceeds to the step S75 when this condition is satisfied, or finishes the station side processing when this condition is not satisfied.

At the step S75, the station CPU 56 outputs the reel stopping result signal regarding the identification information for distinguishing the own station 10 from the other stations 10 and the central dice symbol 45 among the rearranged three dice symbols 45 to the server CPU 49.

At the step S76, the station CPU 56 waits until the judgment result signal is given from the server CPU 49, and proceeds to the step S77 when the judgment result signal is given.

At the step S77, the station CPU 56 judges whether a payout of medals is to be made or not according to the judgment result signal, and proceeds to the step S78 when the payout of medals is to be made, or proceeds to the step S79 when the payout of medals is not to be made.

At the step S78, the station CPU 56 recognizes the number of medals to be paid to the player in the roulette game and the number of medals to be paid to the player in the slot game according to the judgment result signal. The station CPU 56 displays the number of medals to be paid to the player in the roulette game inside the acquired medal number display frame 25, and displays the number of medals to be paid to the player in the slot game inside the acquired medal number display frame 35. In addition, the station CPU 56 adds a total of the number of medals to be paid to the player in the roulette game and the number of medals to be paid to the player in the slot game to a value of the total credit number counter, sets a value obtained by this as a new value of the total credit number counter, and displays the new value of the total credit number counter inside the credit number display frame 26.

At the step S79, the station CPU 56 deletes all the chips 151, and displays “0” inside the betting number display frames 24 and 34 and the acquired medal number display frames 25 and 35. In addition, the station CPU 56 deletes unnecessary data (the betting operation information, for example) among data stored in the station RAM 51. Here, however, the value of the total credit number counter will not be deleted. After that, the station CPU 56 finishes the station side processing.

The credit increasing processing is the same as that shown in FIG. 14, so that its description will be omitted.

As described above, in the third embodiment, the gaming device 1a provides a new multiple participant type game in which whether medals are to be paid at each station 10 or not is determined according to the two dice symbols for judgment displayed by the dice rotation device 2, the one dice symbol for judgment rearranged individually at each station 10, the number of the ball receiving pocket, and a result of the betting operation. In addition, a player cannot judge what level of a payout of medals can be received by himself or not unless attentions are paid to all of the dice rotation device 2, the roulette wheel 58 and the station 10 at which a player himself made the betting operation, so that it is expected to be less likely to get bored by the game compared with the case where it suffices to pay attentions only to the dice rotation device 2, the case where it suffices to pay attentions only to the roulette wheel 58, or the case where it suffices to pay attentions only to the station 10 at which a player himself made the betting operation.

### Modification of the Third Embodiment

Next, the modification of the third embodiment will be described. In this modification, the dice rotation device 2 rotates and stops three dices 7. Namely, the dice rotation device 2 displays the three dice symbols for judgment. On the other hand, at the liquid crystal display device 13 of each station 10, an image other than that of the reel 44 is displayed. Namely, the gaming device 1a according to this modification carries out the above described processing according to the three dice symbols for judgment displayed by the dice rotation device 2.

The gaming device 1a according to this modification provides a new multiple participant type game in which whether medals are to be paid at each station 10 or not is determined according to the three dice symbols for judgment displayed by the dice rotation device 2, the number of the ball receiving pocket, and a result of the betting operation.

The gaming device and game playing method thereof according to the embodiment of the present invention has been described above. However, the invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein. In this embodiment, one kind of character image, the frog character image X is used, for example, as the dynamic character image X that is the predetermined character image. However, several kinds of character images may be used as predetermined character images and simultaneously displayed. In such a case, in addition to setting of payouts in this embodiment, setting of payouts according to the kinds of the predetermined character images may be executed. Specifically, a payout amount may be set to vary according to the kinds of the predetermined character images.

Moreover, the effects described in the embodiment of the present invention are only a list of optimum effects achieved by the present invention. Hence, the effects of the present invention are not limited to those described in the embodiment of the present invention.

For example, the roulette wheel 58 may be displayed on the liquid crystal display device 13. The roulette wheel 58 may be a mechanical roulette wheel. The reel 44 may be the so called mechanical reel. The reel 44 to be displayed at one liquid crystal display device 13 is not limited to one. The communications between the server CPU 49 and the station CPU 56 may be wire communications or wireless communications. The slot game using only the reel 44 may be provided separately from the above described game. The symbols may be those other than the dice symbols. The gaming device 1 pays medals as a prize, but a prize may be other than that, such as tickets having similar level of values as medals.

What is claimed is:

1. A gaming device, comprising:
a common display configured to display symbols;
a plurality of stations having an individual display configured to arrange and rearrange symbols; and
a controller configured to determine whether a prize is to be awarded at one of the stations or not, for each station, according to symbols displayed on the common display and symbols rearranged on the individual display provided at the one of the stations.

2. The gaming device as described in claim 1, wherein
each station is capable of accepting a betting operation on a combination of symbols displayed on the common display and symbols rearranged on the individual display of each station, and
the controller is configured to award the prize at an already bet station at which the betting operation is accepted, when the already bet station exists and the combination of symbols displayed on the common display and symbols displayed on the individual display provided at the already bet station coincides with a combination on which the betting operation is made.

3. The gaming device as described in claim 1, wherein
symbols displayed on the common display and symbols arranged and rearranged on the individual display all indicate numerical values, and
the controller is configured to calculate a total of numerical values indicated by symbols displayed on the common display and numerical values indicated by symbols rearranged on the individual display, for each station, and award the prize at a station for which a difference between the calculated total and a prescribed value is smallest.

4. A gaming device, comprising:
a common display configured to display symbols;
a roulette gaming device configured to rotate a roulette wheel having a plurality of pockets to which numbers are set in correspondence in advance, launch a ball that can be received by the pockets onto the roulette wheel, and then stop the roulette wheel;
a plurality of stations capable of accepting a betting operation on any of the pockets; and
a controller configured to determine whether a prize is to be awarded at each station or not, according to symbols displayed on the common display, a pocket which received the ball, and a result of the betting operation.

5. A playing method of a game, comprising:
displaying symbols on a common display;
rearranging symbols arranged on an individual display provided at each of a plurality of stations; and
determining whether a prize is to be awarded at one of the stations or not, for each station, according to symbols displayed on the common display and symbols rearranged on the individual display provided at the one of the stations.

6. The playing method as described in claim 5, further comprising:
accepting at each station a betting operation on a combination of symbols displayed on the common display and symbols rearranged on the individual display of each station, and
awarding the prize at an already bet station at which the betting operation is accepted, when the already bet station exists and the combination of symbols displayed on the common display and symbols displayed on the individual display provided at the already bet station coincides with a combination on which the betting operation is made.

7. The playing method as described in claim 5, further comprising:
displaying symbols indicating numerical values on the common display;
arranging and rearranging symbols indicating numerical values on the individual display;
calculating a total of numerical values indicated by symbols displayed on the common display and numerical values indicated by symbols rearranged on the individual display, for each station; and
awarding the prize at a station for which a difference between the calculated total and a prescribed value is smallest.

8. A playing method of a game, comprising:
displaying symbols on a common display;
rotating a roulette wheel having a plurality of pockets to which numbers are set in correspondence in advance, launching a ball that can be received by the pockets onto the roulette wheel, and then stopping the roulette wheel;
accepting a betting operation on any of the pockets at each of a plurality of stations; and
determining whether a prize is to be awarded at each station or not, according to symbols displayed on the common display, a pocket which received the ball, and a result of the betting operation.
